(19) United States
(12) Patent Application Publication
(10) Pub. No.: US 2026/0261859 A1
(43) Pub. Date: Sep. 3, 2026

(54) REPORTING HASHED EXPECTED CHANNEL MEASUREMENTS

(71) Applicant: QUALCOMM Incorporated, San Diego, CA (US)

(72) Inventors: Ahmed ELSHAFIE, San Diego, CA (US); Alexandros MANOLAKOS, Athens (GR)

(21) Appl. No.: 18/846,865

(22) PCT Filed: Feb. 1, 2023
(86) PCT No.: PCT/US2023/061781

§ 371 Date: Sep. 13, 2024

(30) Foreign Application Priority Data
Apr. 6, 2022 (GR) 20220100302

(51) Int. Cl. H04W 12/104; H04B 17/318; H04L 5/00; H04W 12/122; H04W 76/20

(52) U.S. Cl. CPC H04W 12/104; H04B 17/328; H04L 5/0051; H04W 12/122; H04W 76/20

(57) ABSTRACT

In an aspect, a network node may receive a first set of one or more hashed values, wherein the first set of one or more hashed values is based on one or more hashing operations applied to expected measurement values of positioning reference signal (PRS) resources of one or more transmission-reception points (TRPs). The network node may measure the PRS resources to obtain actual measurement values. The network node may determine whether the actual measurement values of the PRS resources are within acceptable limits of the expected measurement values based on a comparison of a second set of hashed values with the first set of hashed values, wherein the second set of hashed values is based on application of the one or more hashing operations to the actual measurement values.

### CROSS-REFERENCE TO RELATED APPLICATIONS

The present Application for Patent claims priority to Greek Patent Application No. 20220100302, entitled “REPORTING HASHED EXPECTED CHANNEL MEASUREMENTS,” filed Apr. 6, 2022, and is a national stage application, filed under 35 U.S.C. § 371, of International Patent Application No. PCT/US2023/061781, entitled “REPORTING HASHED EXPECTED CHANNEL MEASUREMENTS,” filed Feb. 1, 2023, both of which are assigned to the assignee hereof and expressly incorporated herein by reference in their entirety.

### BACKGROUND OF THE DISCLOSURE

### 1. Field of the Disclosure

Aspects of the disclosure relate generally to wireless communications.

### 2. Description of the Related Art

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long-Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)), and other technical enhancements. These enhancements, as well as the use of higher frequency bands, advances in PRS processes and technology, and high-density deployments for 5G, enable highly accurate 5G-based positioning.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of wireless communication performed by a network node includes receiving a first set of one or more hashed values, wherein the first set of one or more hashed values is based on one or more hashing operations applied to one or more expected measurement values of one or more positioning reference signal (PRS) resources of one or more transmission-reception points (TRPs); measuring the one or more PRS resources to obtain one or more actual measurement values; and determining whether the one or more actual measurement values of the one or more PRS resources are within acceptable limits of the one or more expected measurement values based on a comparison of a second set of one or more hashed values with the first set of one or more hashed values, wherein the second set of one or more hashed values is based on application of the one or more hashing operations to the one or more actual measurement values.

In an aspect, a method of wireless communication performed by a network node comprises: receiving, from a location server, a first set of one or more hashed values, wherein the first set of one or more hashed values is based on one or more hashing operations applied to one or more expected measurement values, wherein the one or more expected measurement values correspond to expected measurements of one or more positioning reference signal (PRS) resources of one or more transmission-reception points (TRPs) measured by a user equipment (UE) during a positioning session; and using the first set of one or more hashed values for PRS attack detection.

In an aspect, a network node includes a memory; at least one transceiver; and at least one processor communicatively coupled to the memory and the at least one transceiver, the at least one processor configured to: receive, via the at least one transceiver, a first set of one or more hashed values, wherein the first set of one or more hashed values is based on one or more hashing operations applied to one or more expected measurement values of one or more positioning reference signal (PRS) resources of one or more transmission-reception points (TRPs); measure the one or more PRS resources to obtain one or more actual measurement values; and determine whether the one or more actual measurement values of the one or more PRS resources are within acceptable limits of the one or more expected measurement values based on a comparison of a second set of one or more hashed values with the first set of one or more hashed values, wherein the second set of one or more hashed values is based on application of the one or more hashing operations to the one or more actual measurement values.

In an aspect, a network node includes a memory; at least one transceiver; and at least one processor communicatively coupled to the memory and the at least one transceiver, the at least one processor configured to: receive, via the at least one transceiver, from a location server, a first set of one or more hashed values, wherein the first set of one or more hashed values is based on one or more hashing operations applied to one or more expected measurement values, wherein the one or more expected measurement values correspond to expected measurements of one or more positioning reference signal (PRS) resources of one or more transmission-reception points (TRPs) measured by a user equipment (UE) during a positioning session; and use the first set of one or more hashed values for PRS attack detection.

In an aspect, a network node includes means for receiving a first set of one or more hashed values, wherein the first set of one or more hashed values is based on one or more hashing operations applied to one or more expected measurement values of one or more positioning reference signal (PRS) resources of one or more transmission-reception points (TRPs); means for measuring the one or more PRS resources to obtain one or more actual measurement values; and means for determining whether the one or more actual measurement values of the one or more PRS resources are within acceptable limits of the one or more expected measurement values based on a comparison of a second set of one or more hashed values with the first set of one or more hashed values, wherein the second set of one or more hashed values is based on application of the one or more hashing operations to the one or more actual measurement values.

In an aspect, a network node includes means for receiving, from a location server, a first set of one or more hashed values, wherein the first set of one or more hashed values is based on one or more hashing operations applied to one or more expected measurement values, wherein the one or more expected measurement values correspond to expected measurements of one or more positioning reference signal (PRS) resources of one or more transmission-reception points (TRPs) measured by a user equipment (UE) during a positioning session; and means for using the first set of one or more hashed values for PRS attack detection.

In an aspect, a non-transitory computer-readable medium storing computer-executable instructions that, when executed by a network node, cause the network node to: receive a first set of one or more hashed values, wherein the first set of one or more hashed values is based on one or more hashing operations applied to one or more expected measurement values of one or more positioning reference signal (PRS) resources of one or more transmission-reception points (TRPs); measure the one or more PRS resources to obtain one or more actual measurement values; and determine whether the one or more actual measurement values of the one or more PRS resources are within acceptable limits of the one or more expected measurement values based on a comparison of a second set of one or more hashed values with the first set of one or more hashed values, wherein the second set of one or more hashed values is based on application of the one or more hashing operations to the one or more actual measurement values.

In an aspect, a non-transitory computer-readable medium stores computer-executable instructions that, when executed by a network node, cause the network node to: receive, from a location server, a first set of one or more hashed values, wherein the first set of one or more hashed values is based on one or more hashing operations applied to one or more expected measurement values, wherein the one or more expected measurement values correspond to expected measurements of one or more positioning reference signal (PRS) resources of one or more transmission-reception points (TRPs) measured by a user equipment (UE) during a positioning session; and use the first set of one or more hashed values for PRS attack detection.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A and 2B illustrate example wireless network structures, according to aspects of the disclosure.

FIGS. 3A, 3B, and 3C are simplified block diagrams of several sample aspects of components that may be employed in a user equipment (UE), a base station, and a network node, respectively, and configured to support communications as taught herein.

FIG. 4 illustrates an example Long-Term Evolution (LTE) positioning protocol (LPP) call flow between a UE and a location server for performing positioning operations.

FIG. 5 is a diagram illustrating an example frame structure, according to aspects of the disclosure.

FIG. 6 illustrates examples of various positioning methods supported in New Radio (NR), according to aspects of the disclosure.

FIG. 7 illustrates a time difference of arrival (TDOA)-based positioning procedure in an example wireless communications system, according to aspects of the disclosure.

FIG. 8 is a diagram illustrating an example base station in communication with an example UE, according to aspects of the disclosure.

FIG. 9 illustrates example network node location service procedures, according to aspects of the disclosure.

FIG. 10 is a graph representing a radio frequency (RF) channel impulse response over time, according to aspects of the disclosure.

FIG. 11 illustrates an example method of wireless communication performed by a network node, according to aspects of the disclosure.

FIG. 12 illustrates an example method of wireless communication performed by a network node, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

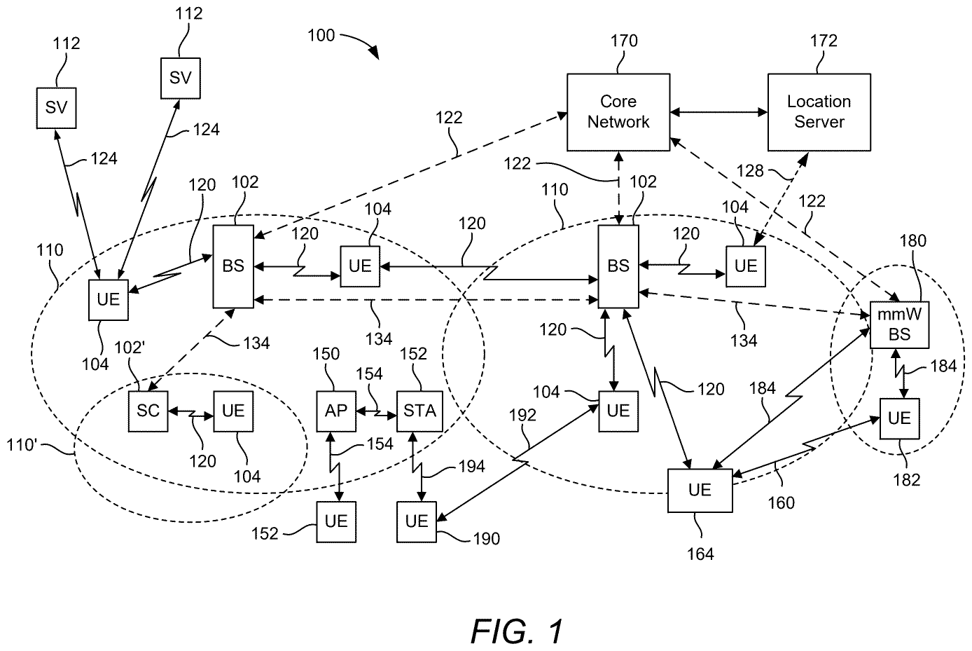

FIG. 1 illustrates an example wireless communications system 100, according to aspects of the disclosure. The wireless communications system 100 (which may also be referred to as a wireless wide area network (WWAN)) may include various base stations 102 (labeled “BS”) and various UEs 104. The base stations 102 may include macro cell base stations (high power cellular base stations) and/or small cell base stations (low power cellular base stations). In an aspect, the macro cell base stations may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a WLAN access point (AP) (e.g., AP 150 described below), and so on. For signaling purposes, communication between a UE 104 and a location server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labeled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a WLAN access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW RF band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the EHF band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

The wireless communications system 100 may further include a UE 164 that may communicate with a macro cell base station 102 over a communication link 120 and/or the mmW base station 180 over a mmW communication link 184. For example, the macro cell base station 102 may support a PCell and one or more SCells for the UE 164 and the mmW base station 180 may support one or more SCells for the UE 164.

In some cases, the UE 164 and the UE 182 may be capable of sidelink communication. Sidelink-capable UEs (SL-UEs) may communicate with base stations 102 over communication links 120 using the Uu interface (i.e., the air interface between a UE and a base station). SL-UEs (e.g., UE 164, UE 182) may also communicate directly with each other over a wireless sidelink 160 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, vehicle-to-vehicle (V2V) communication, vehicle-to-everything (V2X) communication (e.g., cellular V2X (cV2X) communication, enhanced V2X (eV2X) communication, etc.), emergency rescue applications, etc. One or more of a group of SL-UEs utilizing sidelink communications may be within the geographic coverage area 110 of a base station 102. Other SL-UEs in such a group may be outside the geographic coverage area 110 of a base station 102 or be otherwise unable to receive transmissions from a base station 102. In some cases, groups of SL-UEs communicating via sidelink communications may utilize a one-to-many (1:M) system in which each SL-UE transmits to every other SL-UE in the group. In some cases, a base station 102 facilitates the scheduling of resources for sidelink communications. In other cases, sidelink communications are carried out between SL-UEs without the involvement of a base station 102.

In an aspect, the sidelink 160 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs. In an aspect, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by WLAN technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Note that although FIG. 1 only illustrates two of the UEs as SL-UEs (i.e., UEs 164 and 182), any of the illustrated UEs may be SL-UEs. Further, although only UE 182 was described as being capable of beamforming, any of the illustrated UEs, including UE 164, may be capable of beamforming. Where SL-UEs are capable of beamforming, they may beamform toward each other (i.e., toward other SL-UEs), toward other UEs (e.g., UEs 104), toward base stations (e.g., base stations 102, 180, small cell 102′, access point 150), etc. Thus, in some cases, UEs 164 and 182 may utilize beamforming over sidelink 160.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WiFi Direct (WiFi-D), Bluetooth®, and so on.

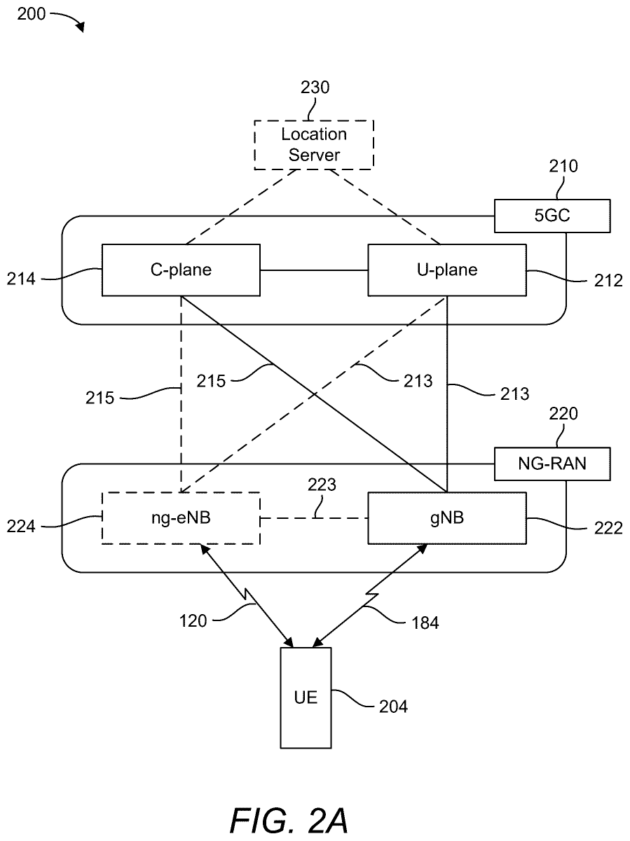

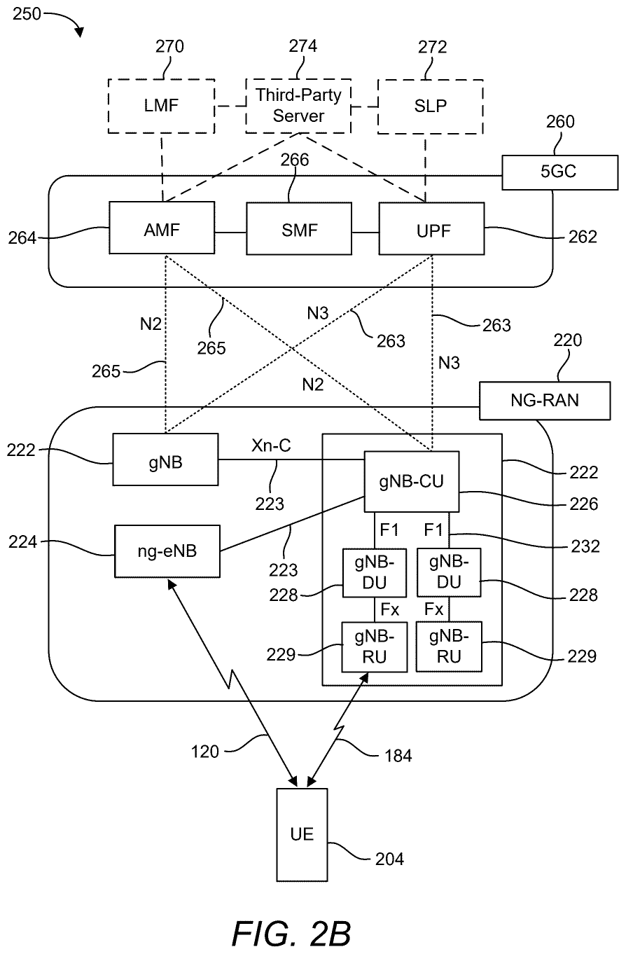

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, Internet protocol (IP) routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third-party server, such as an original equipment manufacturer (OEM) server or service server).

FIG. 2B illustrates another example wireless network structure 250. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a LMF 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP (Third Generation Partnership Project) access networks.

Functions of the UPF 262 include acting as an anchor point for intra-/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QoS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE IP address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (e.g., third-party server 274) over a user plane (e.g., using protocols intended to carry voice and/or data like the transmission control protocol (TCP) and/or IP).

Yet another optional aspect may include a third-party server 274, which may be in communication with the LMF 270, the SLP 272, the 5GC 260 (e.g., via the AMF 264 and/or the UPF 262), the NG-RAN 220, and/or the UE 204 to obtain location information (e.g., a location estimate) for the UE 204. As such, in some cases, the third-party server 274 may be referred to as a location services (LCS) client or an external client. The third-party server 274 can be implemented as a plurality of separate servers (e.g., physically separate servers, different software modules on a single server, different software modules spread across multiple physical servers, etc.), or alternately may each correspond to a single server.

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 may be divided between a gNB central unit (gNB-CU) 226, one or more gNB distributed units (gNB-DUs) 228, and one or more gNB radio units (gNB-RUs) 229. A gNB-CU 226 is a logical node that includes the base station functions of transferring user data, mobility control, RAN sharing, positioning, session management, and the like, except for those functions allocated exclusively to the gNB-DU(s) 228. More specifically, the gNB-CU 226 generally host the RRC, service data adaptation protocol (SDAP), and packet data convergence protocol (PDCP) protocols of the gNB 222. A gNB-DU 228 is a logical node that generally hosts the radio link control (RLC) and medium access control (MAC) layer of the gNB 222. Its operation is controlled by the gNB-CU 226. One gNB-DU 228 can support one or more cells, and one cell is supported by only one gNB-DU 228. The interface 232 between the gNB-CU 226 and the one or more gNB-DUs 228 is referred to as the “F1” interface. The physical (PHY) layer functionality of a gNB 222 is generally hosted by one or more standalone gNB-RUs 229 that perform functions such as power amplification and signal transmission/reception. The interface between a gNB-DU 228 and a gNB-RU 229 is referred to as the “Fx” interface. Thus, a UE 204 communicates with the gNB-CU 226 via the RRC, SDAP, and PDCP layers, with a gNB-DU 228 via the RLC and MAC layers, and with a gNB-RU 229 via the PHY layer.

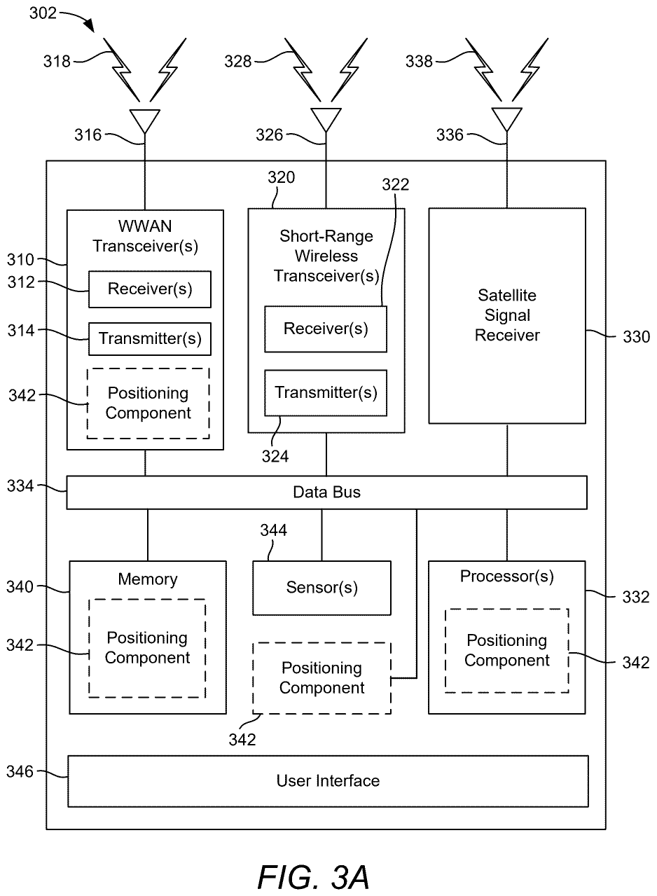

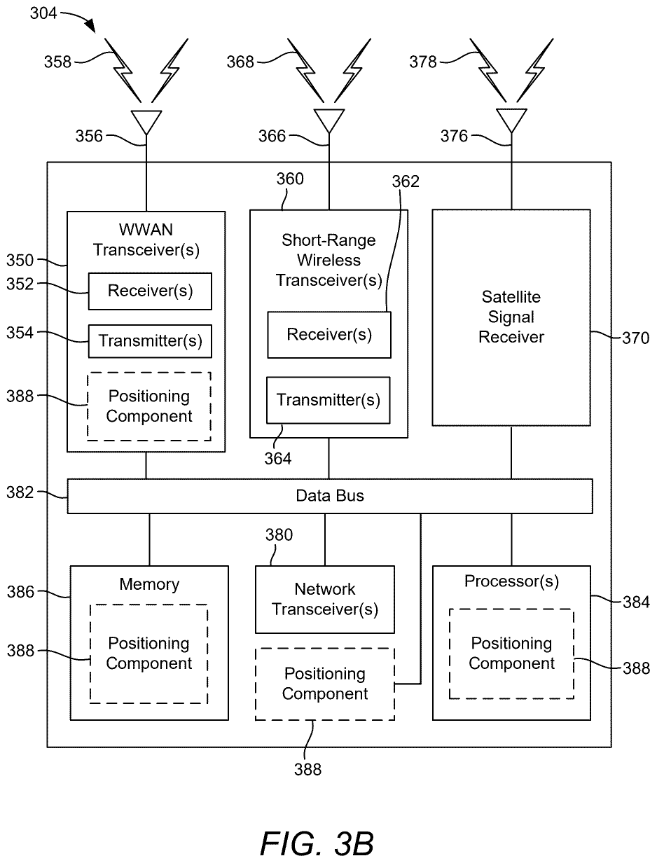

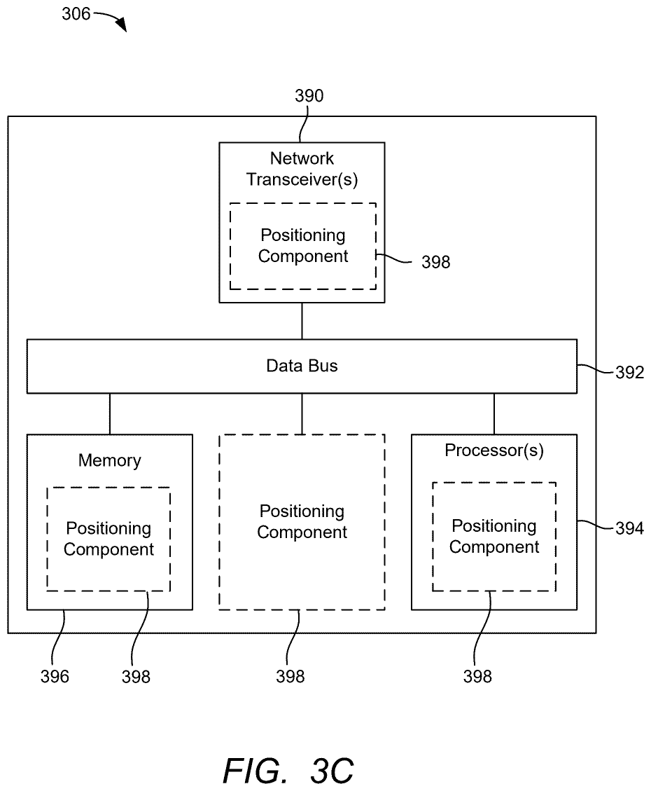

FIGS. 3A, 3B, and 3C illustrate several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the operations described herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include one or more WWAN transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may each be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., WiFi, LTE-D, Bluetooth®, Zigbee®, Z-Wave®, PC5, dedicated short-range communications (DSRC), wireless access for vehicular environments (WAVE), near-field communication (NFC), ultra-wideband (UWB) communications, etc.) over a wireless communication medium of interest. The short-range wireless transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be WiFi transceivers, Bluetooth® transceivers, Zigbee® and/or Z-Wave® transceivers, NFC transceivers, or vehicle-to-vehicle (V2V) and/or vehicle-to-everything (V2X) transceivers.

The UE 302 and the base station 304 also include, at least in some cases, satellite signal receivers 330 and 370. The satellite signal receivers 330 and 370 may be connected to one or more antennas 336 and 376, respectively, and may provide means for receiving and/or measuring satellite positioning/communication signals 338 and 378, respectively. Where the satellite signal receivers 330 and 370 are satellite positioning system receivers, the satellite positioning/communication signals 338 and 378 may be GPS signals, global navigation satellite system (GLONASS) signals, Galileo signals, Beidou signals, Indian Regional Navigation Satellite System (NAVIC), Quasi-Zenith Satellite System (QZSS), etc. Where the satellite signal receivers 330 and 370 are NTN receivers, the satellite positioning/communication signals 338 and 378 may be communication signals (e.g., carrying control and/or user data) originating from a 5G network. The satellite signal receivers 330 and 370 may comprise any suitable hardware and/or software for receiving and processing satellite positioning/communication signals 338 and 378, respectively. The satellite signal receivers 330 and 370 may request information and operations as appropriate from the other systems, and, at least in some cases, perform calculations to determine locations of the UE 302 and the base station 304, respectively, using measurements obtained by any suitable satellite positioning system algorithm.

The base station 304 and the network entity 306 each include one or more network transceivers 380 and 390, respectively, providing means for communicating (e.g., means for transmitting, means for receiving, etc.) with other network entities (e.g., other base stations 304, other network entities 306). For example, the base station 304 may employ the one or more network transceivers 380 to communicate with other base stations 304 or network entities 306 over one or more wired or wireless backhaul links. As another example, the network entity 306 may employ the one or more network transceivers 390 to communicate with one or more base station 304 over one or more wired or wireless backhaul links, or with other network entities 306 over one or more wired or wireless core network interfaces.

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 302, base station 304) to perform transmit “beamforming,” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 302, base station 304) to perform receive beamforming, as described herein. In an aspect, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., WWAN transceivers 310 and 350, short-range wireless transceivers 320 and 360) may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 302) and a base station (e.g., base station 304) will generally relate to signaling via a wireless transceiver.

The UE 302, the base station 304, and the network entity 306 also include other components that may be used in conjunction with the operations as disclosed herein. The UE 302, the base station 304, and the network entity 306 include one or more processors 332, 384, and 394, respectively, for providing functionality relating to, for example, wireless communication, and for providing other processing functionality. The processors 332, 384, and 394 may therefore provide means for processing, such as means for determining, means for calculating, means for receiving, means for transmitting, means for indicating, etc. In an aspect, the processors 332, 384, and 394 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 302, the base station 304, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 302, the base station 304, and the network entity 306 may include positioning component 342, 388, and 398, respectively. The positioning component 342, 388, and 398 may be hardware circuits that are part of or coupled to the processors 332, 384, and 394, respectively, that, when executed, cause the UE 302, the base station 304, and the network entity 306 to perform the functionality described herein. In other aspects, the positioning component 342, 388, and 398 may be external to the processors 332, 384, and 394 (e.g., part of a modem processing system, integrated with another processing system, etc.). Alternatively, the positioning component 342, 388, and 398 may be memory modules stored in the memories 340, 386, and 396, respectively, that, when executed by the processors 332, 384, and 394 (or a modem processing system, another processing system, etc.), cause the UE 302, the base station 304, and the network entity 306 to perform the functionality described herein. FIG. 3A illustrates possible locations of the positioning component 342, which may be, for example, part of the one or more WWAN transceivers 310, the memory 340, the one or more processors 332, or any combination thereof, or may be a standalone component. FIG. 3B illustrates possible locations of the positioning component 388, which may be, for example, part of the one or more WWAN transceivers 350, the memory 386, the one or more processors 384, or any combination thereof, or may be a standalone component. FIG. 3C illustrates possible locations of the positioning component 398, which may be, for example, part of the one or more network transceivers 390, the memory 396, the one or more processors 394, or any combination thereof, or may be a standalone component.

The UE 302 may include one or more sensors 344 coupled to the one or more processors 332 to provide means for sensing or detecting movement and/or orientation information that is independent of motion data derived from signals received by the one or more WWAN transceivers 310, the one or more short-range wireless transceivers 320, and/or the satellite signal receiver 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the one or more processors 384 in more detail, in the downlink, IP packets from the network entity 306 may be provided to the processor 384. The one or more processors 384 may implement functionality for an RRC layer, a PDCP layer, a RLC layer, and a MAC layer. The one or more processors 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the one or more processors 332. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the one or more processors 332, which implements Layer-3 (L3) and Layer-2 (L2) functionality.

In the uplink, the one or more processors 332 provides demultiplexing between transport and logical channels, packet reassembly, deciphering, header decompression, and control signal processing to recover IP packets from the core network. The one or more processors 332 are also responsible for error detection.

Similar to the functionality described in connection with the downlink transmission by the base station 304, the one or more processors 332 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering, header decompression, control signal processing to recover IP packets from the UE 302. IP packets from the one or more processors 384 may be provided to the core network. The one or more processors 384 are also responsible for error detection.

For convenience, the UE 302, the base station 304, and/or the network entity 306 are shown in FIGS. 3A, 3B, and 3C as including various components that may be configured according to the various examples described herein. It will be appreciated, however, that the illustrated components may have different functionality in different designs. In particular, various components in FIGS. 3A to 3C are optional in alternative configurations and the various aspects include configurations that may vary due to design choice, costs, use of the device, or other considerations. For example, in case of FIG. 3A, a particular implementation of UE 302 may omit the WWAN transceiver(s) 310 (e.g., a wearable device or tablet computer or PC or laptop may have Wi-Fi and/or Bluetooth capability without cellular capability), or may omit the short-range wireless transceiver(s) 320 (e.g., cellular-only, etc.), or may omit the satellite signal receiver 330, or may omit the sensor(s) 344, and so on. In another example, in case of FIG. 3B, a particular implementation of the base station 304 may omit the WWAN transceiver(s) 350 (e.g., a Wi-Fi “hotspot” access point without cellular capability), or may omit the short-range wireless transceiver(s) 360 (e.g., cellular-only, etc.), or may omit the satellite receiver 370, and so on. For brevity, illustration of the various alternative configurations is not provided herein, but would be readily understandable to one skilled in the art.

The various components of the UE 302, the base station 304, and the network entity 306 may be communicatively coupled to each other over data buses 334, 382, and 392, respectively. In an aspect, the data buses 334, 382, and 392 may form, or be part of, a communication interface of the UE 302, the base station 304, and the network entity 306, respectively. For example, where different logical entities are embodied in the same device (e.g., gNB and location server functionality incorporated into the same base station 304), the data buses 334, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 302, base station 304, network entity 306, etc., such as the processors 332, 384, 394, the transceivers 310, 320, 350, and 360, the memories 340, 386, and 396, the positioning component 342, 388, and 398, etc.

In some designs, the network entity 306 may be implemented as a core network component. In other designs, the network entity 306 may be distinct from a network operator or operation of the cellular network infrastructure (e.g., NG-RAN 220 and/or 5GC 210/260). For example, the network entity 306 may be a component of a private network that may be configured to communicate with the UE 302 via the base station 304 or independently from the base station 304 (e.g., over a non-cellular communication link, such as WiFi).

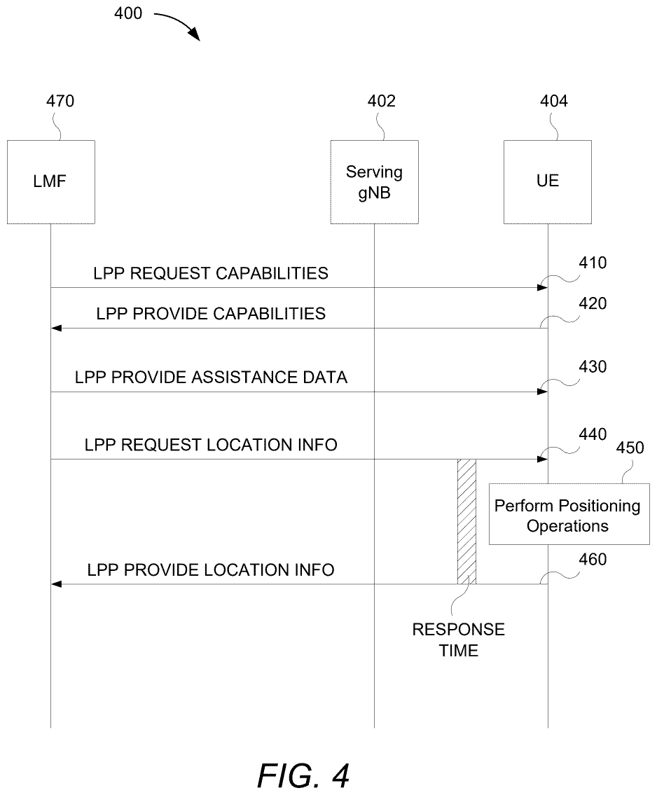

FIG. 4 illustrates an example Long-Term Evolution (LTE) positioning protocol (LPP) procedure 400 between a UE 404 and a location server (illustrated as a LMF 470) for performing positioning operations. As illustrated in FIG. 4, positioning of the UE 404 is supported via an exchange of LPP messages between the UE 404 and the LMF 470. The LPP messages may be exchanged between UE 404 and the LMF 470 via the UE's 404 serving base station (illustrated as a serving gNB 402) and a core network (not shown). The LPP procedure 400 may be used to position the UE 404 in order to support various location-related services, such as navigation for UE 404 (or for the user of UE 404), or for routing, or for provision of an accurate location to a public service access point (PSAP) in association with an emergency call from UE 404 to a PSAP, or for some other reason. The LPP procedure 400 may also be referred to as a positioning session, and there may be multiple positioning sessions for different types of positioning methods (e.g., downlink time difference of arrival (DL-TDOA), round-trip-time (RTT), enhanced cell identity (E-CID), etc.).

Initially, the UE 404 may receive a request for its positioning capabilities from the LMF 470 at stage 410 (e.g., an LPP Request Capabilities message). At stage 420, the UE 404 provides its positioning capabilities to the LMF 470 relative to the LPP protocol by sending an LPP Provide Capabilities message to LMF 470 indicating the position methods and features of these position methods that are supported by the UE 404 using LPP. The capabilities indicated in the LPP Provide Capabilities message may, in some aspects, indicate the type of positioning the UE 404 supports (e.g., DL-TDOA, RTT, E-CID, etc.) and may indicate the capabilities of the UE 404 to support those types of positioning.

Upon reception of the LPP Provide Capabilities message, at stage 420, the LMF 470 determines to use a particular type of positioning method (e.g., DL-TDOA, RTT, E-CID, etc.) based on the indicated type(s) of positioning the UE 404 supports and determines a set of one or more TRPs from which the UE 404 is to measure downlink positioning reference signals or toward which the UE 404 is to transmit uplink positioning reference signals. At stage 430, the LMF 470 sends an LPP Provide Assistance Data message to the UE 404 identifying the set of TRPs.

In some implementations, the LPP Provide Assistance Data message at stage 430 may be sent by the LMF 470 to the UE 404 in response to an LPP Request Assistance Data sent by the UE 404 to the LMF 470 (not shown in FIG. 4). An LPP Request Assistance Data message may include an identifier of the UE's 404 serving TRP and a request for the positioning reference signal (PRS) configuration of neighboring TRPs.

At stage 440, the LMF 470 sends a request for location information to the UE 404. The request may be an LPP Request Location Information message. This message usually includes information elements defining the location information type, desired accuracy of the location estimate, and response time (i.e., desired latency). Note that a low latency requirement allows for a longer response time while a high latency requirement requires a shorter response time. However, a long response time is referred to as high latency and a short response time is referred to as low latency.

Note that in some implementations, the LPP Provide Assistance Data sent at stage 430 may be sent after the LPP Request Location Information message at 440 if, for example, the UE 404 sends a request for assistance data to LMF 470 (e.g., in an LPP Request Assistance Data, not shown in FIG. 4) after receiving the request for location information at stage 440.

At stage 450, the UE 404 utilizes the assistance information received at stage 430 and any additional data (e.g., a desired location accuracy or a maximum response time) received at stage 440 to perform positioning operations (e.g., measurements of DL-PRS, transmission of UL-PRS, etc.) for the selected positioning method.

At stage 460, the UE 404 may send an LPP Provide Location Information message to the LMF 470 conveying the results of any measurements that were obtained at stage 450 (e.g., time of arrival (ToA), reference-signal-time-difference (RSTD), reception-to-transmission (Rx-Tx), etc.) and before or when any maximum response time has expired (e.g., a maximum response time provided by the LMF 470 at stage 440). The LPP Provide Location Information message at stage 460 may also include the time (or times) at which the positioning measurements were obtained and the identity of the TRP(s) from which the positioning measurements were obtained. Note that the time between the request for location information at 440 and the response at 460 is the “response time” and indicates the latency of the positioning session.

The LMF 470 computes an estimated location of the UE 404 using the appropriate positioning techniques (e.g., DL-TDOA, RTT, E-CID, etc.) based, at least in part, on measurements received in the LPP Provide Location Information message at stage 460.

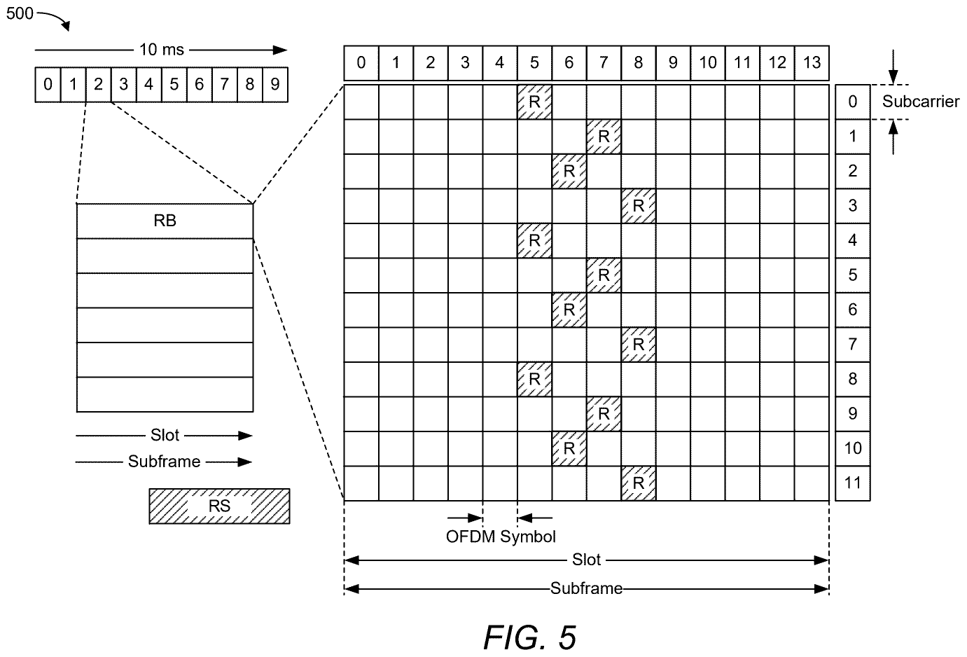

Various frame structures may be used to support downlink and uplink transmissions between network nodes (e.g., base stations and UEs). FIG. 5 is a diagram 500 illustrating an example frame structure, according to aspects of the disclosure. The frame structure may be a downlink or uplink frame structure. Other wireless communications technologies may have different frame structures and/or different channels.

LTE, and in some cases NR, utilizes OFDM on the downlink and single-carrier frequency division multiplexing (SC-FDM) on the uplink. Unlike LTE, however, NR has an option to use OFDM on the uplink as well. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kilohertz (kHz) and the minimum resource allocation (resource block) may be 12 subcarriers (or 180 kHz). Consequently, the nominal FFT size may be equal to 128, 256, 512, 1024, or 2048 for system bandwidth of 1.25, 2.5, 5, 10, or 20 megahertz (MHz), respectively. The system bandwidth may also be partitioned into subbands. For example, a subband may cover 1.08 MHz (i.e., 6 resource blocks), and there may be 1, 2, 4, 8, or 16 subbands for system bandwidth of 1.25, 2.5, 5, 10, or 20 MHz, respectively.

LTE supports a single numerology (subcarrier spacing (SCS), symbol length, etc.). In contrast, NR may support multiple numerologies (μ), for example, subcarrier spacings of 15 kHz (μ=0), 30 kHz (μ=1), 60 kHz (μ=2), 120 kHz (μ=3), and 240 kHz (μ=4) or greater may be available. In each subcarrier spacing, there are 14 symbols per slot. For 15 kHz SCS (μ=0), there is one slot per subframe, 10 slots per frame, the slot duration is 1 millisecond (ms), the symbol duration is 66.7 microseconds (μs), and the maximum nominal system bandwidth (in MHz) with a 4K FFT size is 50. For 30 kHz SCS (μ=1), there are two slots per subframe, 20 slots per frame, the slot duration is 0.5 ms, the symbol duration is 33.3 μs, and the maximum nominal system bandwidth (in MHz) with a 4K FFT size is 100. For 60 kHz SCS (μ=2), there are four slots per subframe, 40 slots per frame, the slot duration is 0.25 ms, the symbol duration is 16.7 μs, and the maximum nominal system bandwidth (in MHz) with a 4K FFT size is 200. For 120 kHz SCS (μ=3), there are eight slots per subframe, 80 slots per frame, the slot duration is 0.125 ms, the symbol duration is 8.33 μs, and the maximum nominal system bandwidth (in MHz) with a 4K FFT size is 400. For 240 kHz SCS (μ=4), there are 16 slots per subframe, 160 slots per frame, the slot duration is 0.0625 ms, the symbol duration is 4.17 μs, and the maximum nominal system bandwidth (in MHz) with a 4K FFT size is 800.

In the example of FIG. 5, a numerology of 15 kHz is used. Thus, in the time domain, a 10 ms frame is divided into 10 equally sized subframes of 1 ms each, and each subframe includes one time slot. In FIG. 5, time is represented horizontally (on the X axis) with time increasing from left to right, while frequency is represented vertically (on the Y axis) with frequency increasing (or decreasing) from bottom to top.

A resource grid may be used to represent time slots, each time slot including one or more time-concurrent resource blocks (RBs) (also referred to as physical RBs (PRBs)) in the frequency domain. The resource grid is further divided into multiple resource elements (REs). An RE may correspond to one symbol length in the time domain and one subcarrier in the frequency domain. In the numerology of FIG. 5, for a normal cyclic prefix, an RB may contain 12 consecutive subcarriers in the frequency domain and seven consecutive symbols in the time domain, for a total of 84 REs. For an extended cyclic prefix, an RB may contain 12 consecutive subcarriers in the frequency domain and six consecutive symbols in the time domain, for a total of 72 REs. The number of bits carried by each RE depends on the modulation scheme.

Some of the REs may carry reference (pilot) signals (RS). The reference signals may include positioning reference signals (PRS), tracking reference signals (TRS), phase tracking reference signals (PTRS), cell-specific reference signals (CRS), channel state information reference signals (CSI-RS), demodulation reference signals (DMRS), primary synchronization signals (PSS), secondary synchronization signals (SSS), SSBs, SRS, etc., depending on whether the illustrated frame structure is used for uplink or downlink communication. FIG. 5 illustrates example locations of REs carrying a reference signal (labeled “R”).

In an aspect, the reference signal carried on the REs labeled “R” in FIG. 5 may be SRS. SRS transmitted by a UE may be used by a base station to obtain the channel state information (CSI) for the transmitting UE. CSI describes how an RF signal propagates from the UE to the base station and represents the combined effect of scattering, fading, and power decay with distance. The system uses the SRS for resource scheduling, link adaptation, massive MIMO, beam management, etc. In certain aspects, the SRS may be used as an uplink positioning reference signal (UL-PRS).

A collection of REs that are used for transmission of PRS is referred to as a “PRS resource.” The collection of REs can span multiple PRBs in the frequency domain and ‘N’ (such as 1 or more) consecutive symbol(s) within a slot in the time domain. In a given OFDM symbol in the time domain, a PRS resource occupies consecutive PRBs in the frequency domain.

The transmission of a PRS resource within a given PRB has a particular comb size (also referred to as the “comb density”). A comb size ‘N’ represents the subcarrier spacing (or frequency/tone spacing) within each symbol of a PRS resource configuration. Specifically, for a comb size ‘N,’ PRS are transmitted in every Nth subcarrier of a symbol of a PRB. For example, for comb-4, for each symbol of the PRS resource configuration, REs corresponding to every fourth subcarrier (such as subcarriers 0, 4, 8) are used to transmit PRS of the PRS resource. Currently, comb sizes of comb-2, comb-4, comb-6, and comb-12 are supported for DL-PRS. FIG. 5 illustrates an example PRS resource configuration for comb-4 (which spans four symbols). That is, the locations of the shaded REs (labeled “R”) indicate a comb-4 PRS resource configuration.

Currently, a DL-PRS resource may span 2, 4, 6, or 12 consecutive symbols within a slot with a fully frequency domain staggered pattern. A DL-PRS resource can be configured in any higher layer configured downlink or flexible (FL) symbol of a slot. There may be a constant energy per resource element (EPRE) for all REs of a given DL-PRS resource. The following are the frequency offsets from symbol to symbol for comb sizes 2, 4, 6, and 12 over 2, 4, 6, and 12 symbols. 2-symbol comb-2: {0, 1}; 4-symbol comb-2: {0, 1, 0, 1}; 6-symbol comb-2: {0, 1, 0, 1, 0, 1}; 12-symbol comb-2: {0, 1, 0, 1, 0, 1, 0, 1, 0, 1, 0, 1}; 4-symbol comb-4: {0, 2, 1, 3} (as in the example of FIG. 5); 12-symbol comb-4: {0, 2, 1, 3, 0, 2, 1, 3, 0, 2, 1, 3}; 6-symbol comb-6: {0, 3, 1, 4, 2, 5}; 12-symbol comb-6: {0, 3, 1, 4, 2, 5, 0, 3, 1, 4, 2, 5}; and 12-symbol comb-12: {0, 6, 3, 9, 1, 7, 4, 10, 2, 8, 5, 11}.

A “PRS resource set” is a set of PRS resources used for the transmission of PRS signals, where each PRS resource has a PRS resource ID. In addition, the PRS resources in a PRS resource set are associated with the same TRP. A PRS resource set is identified by a PRS resource set ID and is associated with a particular TRP (identified by a TRP ID). In addition, the PRS resources in a PRS resource set have the same periodicity, a common muting pattern configuration, and the same repetition factor (such as “PRS-ResourceRepetitionFactor”) across slots. The periodicity is the time from the first repetition of the first PRS resource of a first PRS instance to the same first repetition of the same first PRS resource of the next PRS instance. The periodicity may have a length selected from 2\hat{ }μ*{4, 5, 8, 10, 16, 20, 32, 40, 64, 80, 160, 320, 640, 1280, 2560, 5120, 10240}slots, with μ=0, 1, 2, 3. The repetition factor may have a length selected from {1, 2, 4, 6, 8, 16, 32} slots.

A PRS resource ID in a PRS resource set is associated with a single beam (or beam ID) transmitted from a single TRP (where a TRP may transmit one or more beams). That is, each PRS resource of a PRS resource set may be transmitted on a different beam, and as such, a “PRS resource,” or simply “resource,” also can be referred to as a “beam.” Note that this does not have any implications on whether the TRPs and the beams on which PRS are transmitted are known to the UE.

A “PRS instance” or “PRS occasion” is one instance of a periodically repeated time window (such as a group of one or more consecutive slots) where PRS are expected to be transmitted. A PRS occasion also may be referred to as a “PRS positioning occasion,” a “PRS positioning instance,” a “positioning occasion,” “a positioning instance,” a “positioning repetition,” or simply an “occasion,” an “instance,” or a “repetition.”

A “positioning frequency layer” (also referred to simply as a “frequency layer”) is a collection of one or more PRS resource sets across one or more TRPs that have the same values for certain parameters. Specifically, the collection of PRS resource sets has the same subcarrier spacing and cyclic prefix (CP) type (meaning all numerologies supported for the physical downlink shared channel (PDSCH) are also supported for PRS), the same Point A, the same value of the downlink PRS bandwidth, the same start PRB (and center frequency), and the same comb size. The Point A parameter takes the value of the parameter “ARFCN-ValueNR” (where “ARFCN” stands for “absolute radio-frequency channel number”) and is an identifier/code that specifies a pair of physical radio channel used for transmission and reception. The downlink PRS bandwidth may have a granularity of four PRBs, with a minimum of 24 PRBs and a maximum of 272 PRBs. Currently, up to four frequency layers have been defined, and up to two PRS resource sets may be configured per TRP per frequency layer.

The concept of a frequency layer is somewhat like the concept of component carriers and bandwidth parts (BWPs), but different in that component carriers and BWPs are used by one base station (or a macro cell base station and a small cell base station) to transmit data channels, while frequency layers are used by several (usually three or more) base stations to transmit PRS. A UE may indicate the number of frequency layers it can support when it sends the network its positioning capabilities, such as during an LTE positioning protocol (LPP) session. For example, a UE may indicate whether it can support one or four positioning frequency layers.

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS, SSB, SRS, UL-PRS, etc. In addition, the terms “positioning reference signal” and “PRS” may refer to downlink, uplink, or sidelink positioning reference signals, unless otherwise indicated by the context. If needed to further distinguish the type of PRS, a downlink positioning reference signal may be referred to as a “DL-PRS,” an uplink positioning reference signal (e.g., an SRS-for-positioning, PTRS) may be referred to as an “UL-PRS,” and a sidelink positioning reference signal may be referred to as an “SL-PRS.” In addition, for signals that may be transmitted in the downlink, uplink, and/or sidelink (e.g., DMRS), the signals may be prepended with “DL,” “UL,” or “SL” to distinguish the direction. For example, “UL-DMRS” is different from “DL-DMRS.”

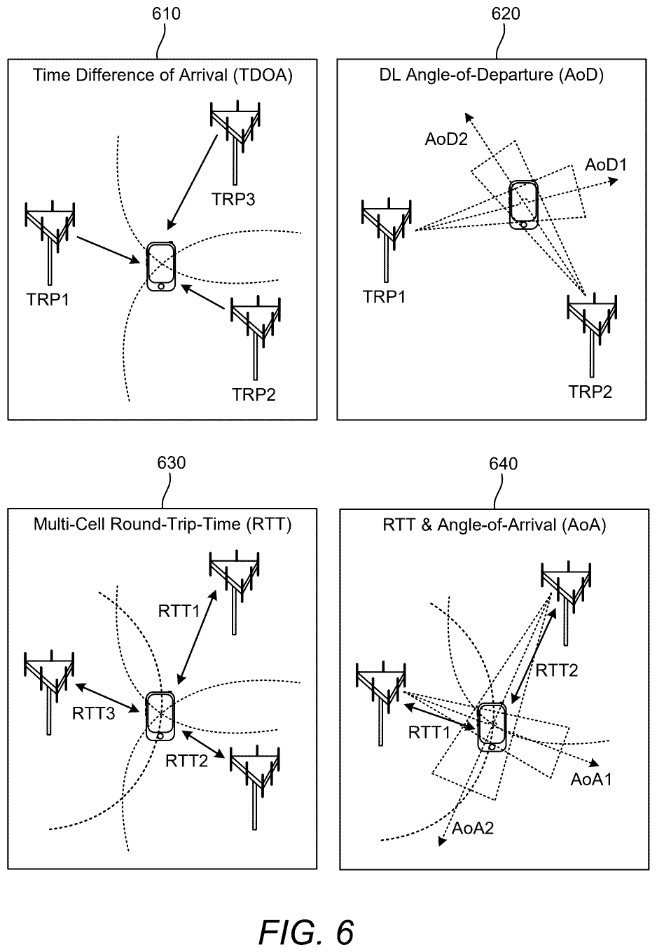

NR supports a number of cellular network-based positioning technologies, including downlink-based, uplink-based, and downlink-and-uplink-based positioning methods. Downlink-based positioning methods include observed time difference of arrival (OTDOA) in LTE, downlink time difference of arrival (DL-TDOA) in NR, and downlink angle-of-departure (DL-AoD) in NR. FIG. 6 illustrates examples of various positioning methods, according to aspects of the disclosure. In an OTDOA or DL-TDOA positioning procedure, illustrated by scenario 610, a UE measures the differences between the ToAs of reference signals (e.g., PRS) received from pairs of base stations, referred to as RSTD or TDOA measurements, and reports them to a positioning entity. More specifically, the UE receives the identifiers (IDs) of a reference base station (e.g., a serving base station) and multiple non-reference base stations in assistance data (assistance data). The UE then measures the RSTD between the reference base station and each of the non-reference base stations. Based on the known locations of the involved base stations and the RSTD measurements, the positioning entity (e.g., the UE for UE-based positioning or a location server for UE-assisted positioning) can estimate the UE's location.

For DL-AoD positioning, illustrated by scenario 620, the positioning entity uses a measurement report from the UE of received signal strength measurements of multiple downlink transmit beams to determine the angle(s) between the UE and the transmitting base station(s). The positioning entity can then estimate the location of the UE based on the determined angle(s) and the known location(s) of the transmitting base station(s).

Uplink-based positioning methods include uplink time difference of arrival (UL-TDOA) and uplink angle-of-arrival (UL-AoA). UL-TDOA is similar to DL-TDOA, but is based on uplink reference signals (e.g., SRS) transmitted by the UE to multiple base stations. Specifically, a UE transmits one or more uplink reference signals that are measured by a reference base station and a plurality of non-reference base stations. Each base station then reports the reception time (referred to as the relative time of arrival (RTOA)) of the reference signal(s) to a positioning entity (e.g., a location server) that knows the locations and relative timing of the involved base stations. Based on the reception-to-reception (Rx-Rx) time difference between the reported RTOA of the reference base station and the reported RTOA of each non-reference base station, the known locations of the base stations, and their known timing offsets, the positioning entity can estimate the location of the UE using TDOA.

For UL-AoA positioning, one or more base stations measure the received signal strength of one or more uplink reference signals (e.g., SRS) received from a UE on one or more uplink receive beams. The positioning entity uses the signal strength measurements and the angle(s) of the receive beam(s) to determine the angle(s) between the UE and the base station(s). Based on the determined angle(s) and the known location(s) of the base station(s), the positioning entity can then estimate the location of the UE.

Downlink-and-uplink-based positioning methods include enhanced cell-ID (E-CID) positioning and multi-RTT positioning (also referred to as “multi-cell RTT” and “multi-RTT”). In an RTT procedure, a first entity (e.g., a base station or a UE) transmits a first RTT-related signal (e.g., a PRS or SRS) to a second entity (e.g., a UE or base station), which transmits a second RTT-related signal (e.g., an SRS or PRS) back to the first entity. Each entity measures the time difference between the ToA of the received RTT-related signal and the transmission time of the transmitted RTT-related signal. This time difference is referred to as a reception-to-transmission (Rx-Tx) time difference. The Rx-Tx time difference measurement may be made, or may be adjusted, to include only a time difference between nearest slot boundaries for the received and transmitted signals. Both entities may then send their Rx-Tx time difference measurement to a location server (e.g., an LMF 270), which calculates the round trip propagation time (i.e., RTT) between the two entities from the two Rx-Tx time difference measurements (e.g., as the sum of the two Rx-Tx time difference measurements). Alternatively, one entity may send its Rx-Tx time difference measurement to the other entity, which then calculates the RTT. The distance between the two entities can be determined from the RTT and the known signal speed (e.g., the speed of light). For multi-RTT positioning, illustrated by scenario 630, a first entity (e.g., a UE or base station) performs an RTT positioning procedure with multiple second entities (e.g., multiple base stations or UEs) to enable the location of the first entity to be determined (e.g., using multilateration) based on distances to, and the known locations of, the second entities. RTT and multi-RTT methods can be combined with other positioning techniques, such as UL-AoA and DL-AoD, to improve location accuracy, as illustrated by scenario 640.

The E-CID positioning method is based on radio resource management (RRM) measurements. In E-CID, the UE reports the serving cell ID, the timing advance (TA), and the identifiers, estimated timing, and signal strength of detected neighbor base stations. The location of the UE is then estimated based on this information and the known locations of the base station(s).

To assist positioning operations, a location server (e.g., location server 230, LMF 270, SLP 272) may provide assistance data to the UE. For example, the assistance data may include identifiers of the base stations (or the cells/TRPs of the base stations) from which to measure reference signals, the reference signal configuration parameters (e.g., the number of consecutive slots including PRS, periodicity of the consecutive slots including PRS, muting sequence, frequency hopping sequence, reference signal identifier, reference signal bandwidth, etc.), and/or other parameters applicable to the particular positioning method. Alternatively, the assistance data may originate directly from the base stations themselves (e.g., in periodically broadcasted overhead messages, etc.). In some cases, the UE may be able to detect neighbor network nodes itself without the use of assistance data.

In the case of an OTDOA or DL-TDOA positioning procedure, the assistance data may further include an expected RSTD value and an associated uncertainty, or search window, around the expected RSTD. In some cases, the value range of the expected RSTD may be +/−500 microseconds (μs). In some cases, when any of the resources used for the positioning measurement are in FR1, the value range for the uncertainty of the expected RSTD may be +/−32 μs. In other cases, when all of the resources used for the positioning measurement(s) are in FR2, the value range for the uncertainty of the expected RSTD may be +/−8 μs.

A location estimate may be referred to by other names, such as a position estimate, location, position, position fix, fix, or the like. A location estimate may be geodetic and comprise coordinates (e.g., latitude, longitude, and possibly altitude) or may be civic and comprise a street address, postal address, or some other verbal description of a location. A location estimate may further be defined relative to some other known location or defined in absolute terms (e.g., using latitude, longitude, and possibly altitude). A location estimate may include an expected error or uncertainty (e.g., by including an area or volume within which the location is expected to be included with some specified or default level of confidence).

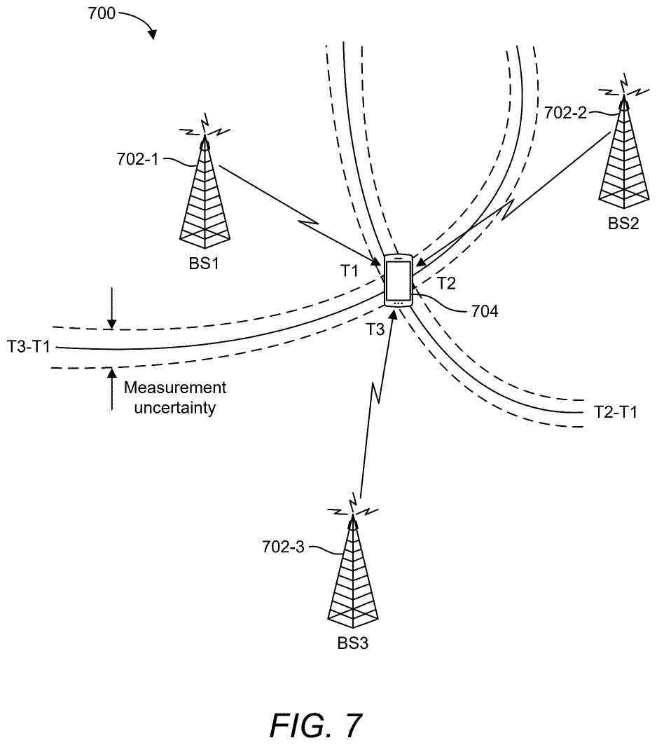

FIG. 7 illustrates a TDOA-based positioning procedure in an example wireless communications system 700, according to aspects of the disclosure. The TDOA-based positioning procedure may be an OTDOA positioning procedure, as in LTE, or a downlink time difference of arrival (DL-TDOA) positioning procedure, as in 5G NR. In the example of FIG. 7, a UE 704 (e.g., any of the UEs described herein) is attempting to calculate an estimate of its location (referred to as “UE-based” positioning), or assist another entity (e.g., a base station or core network component, another UE, a location server, a third-party application, etc.) to calculate an estimate of its location (referred to as “UE-assisted” positioning). The UE 704 may communicate with (e.g., send information to and receive information from) one or more of a plurality of base stations 702 (e.g., any combination of base stations described herein), labeled “BS1” 702-1, “BS2” 702-2, and “BS3” 702-3.

To support location estimates, the base stations 702 may be configured to broadcast PRS, TRS, CRS, channel state information reference signals (CSI-RS), demodulation reference signals (DMRS), etc.) to a UE 704 in their coverage areas to enable the UE 704 to measure characteristics of such reference signals. In a TDOA-based positioning procedure, the UE 704 measures the time difference, known as the RSTD or TDOA, between specific downlink reference signals (e.g., PRS, TRS, CRS, CSI-RS, etc.) transmitted by different pairs of base stations 702, and either reports these RSTD measurements to a location server (e.g., location server 230, LMF 270, SLP 272) or computes a location estimate itself from the RSTD measurements.

Generally, RSTDs are measured between a reference cell (e.g., a cell supported by base station 702-1 in the example of FIG. 7) and one or more neighbor cells (e.g., cells supported by base stations 702-2 and 702-3 in the example of FIG. 7). The reference cell remains the same for all RSTDs measured by the UE 704 for any single positioning use of TDOA and would typically correspond to the serving cell for the UE 704 or another nearby cell with good signal strength at the UE 704. In an aspect, the neighbor cells would normally be cells supported by base stations different from the base station for the reference cell, and may have good or poor signal strength at the UE 704. The location computation can be based on the measured RSTDs and knowledge of the involved base stations' 702 locations and relative transmission timing (e.g., regarding whether base stations 702 are accurately synchronized or whether each base station 702 transmits with some known time offset relative to other base stations 702).

To assist TDOA-based positioning operations, the location server (e.g., location server 230, LMF 270, SLP 272) may provide assistance data to the UE 704 for the reference cell and the neighbor cells relative to the reference cell. For example, the assistance data may include identifiers (e.g., PCI, VCI, CGI, etc.) for each cell of a set of cells that the UE 704 is expected to measure (here, cells supported by the base stations 702). The assistance data may also provide the center channel frequency of each cell, various reference signal configuration parameters (e.g., the number of consecutive positioning slots, periodicity of positioning slots, muting sequence, frequency hopping sequence, reference signal identifier, reference signal bandwidth), and/or other cell related parameters applicable to TDOA-based positioning procedures. The assistance data may also indicate the serving cell for the UE 704 as the reference cell.

In some cases, the assistance data may also include “expected RSTD” parameters, which provide the UE 704 with information about the RSTD values the UE 704 is expected to measure between the reference cell and each neighbor cell at its current location, together with an uncertainty of the expected RSTD parameter. The expected RSTD, together with the associated uncertainty, may define a search window for the UE 704 within which the UE 704 is expected to measure the RSTD value. In some cases, the value range of the expected RSTD may be +/−500 microseconds (μs). In some cases, when any of the resources used for the positioning measurement are in FR1, the value range for the uncertainty of the expected RSTD may be +/−32 μs. In other cases, when all of the resources used for the positioning measurement(s) are in FR2, the value range for the uncertainty of the expected RSTD may be +/−8 μs.

TDOA assistance information may also include positioning reference signal configuration information parameters, which allow the UE 704 to determine when a positioning reference signal occasion will occur on signals received from various neighbor cells relative to positioning reference signal occasions for the reference cell, and to determine the reference signal sequence transmitted from the various cells in order to measure a reference signal ToA or RSTD.

In an aspect, while the location server (e.g., location server 230, LMF 270, SLP 272) may send the assistance data to the UE 704, alternatively, the assistance data can originate directly from the base stations 702 themselves (e.g., in periodically broadcasted overhead messages, etc.). Alternatively, the UE 704 can detect neighbor base stations itself without the use of assistance data.

The UE 704 (e.g., based in part on the assistance data, if provided) can measure and (optionally) report the RSTDs between reference signals received from pairs of base stations 702. Using the RSTD measurements, the known absolute or relative transmission timing of each base station 702, and the known location(s) of the reference and neighbor base stations 702, the network (e.g., location server 230/LMF 270/SLP 272, a base station 702) or the UE 704 can estimate the location of the UE 704. More particularly, the RSTD for a neighbor cell “k” relative to a reference cell “Ref” may be given as (ToA_k−ToA_Ref). In the example of FIG. 7, the measured RSTDs between the reference cell of base station 702-1 and the cells of neighbor base stations 702-2 and 702-3 may be represented as T2−T1 and T3−T1, where T1, T2, and T3 represent the ToA of a reference signal from the base station 702-1, 702-2, and 702-3, respectively. The UE 704 (if it is not the positioning entity) may then send the RSTD measurements to the location server or other positioning entity. Using (i) the RSTD measurements, (ii) the known absolute or relative transmission timing of each base station 702, (iii) the known location(s) of the base stations 702, and/or (iv) directional reference signal characteristics, such as the direction of transmission, the UE's 704 location may be determined (either by the UE 704 or the location server).

In an aspect, the location estimate may specify the location of the UE 704 in a two-dimensional (2D) coordinate system; however, the aspects disclosed herein are not so limited, and may also be applicable to determining location estimates using a three-dimensional (3D) coordinate system, if the extra dimension is desired. Additionally, while FIG. 7 illustrates one UE 704 and three base stations 702, as will be appreciated, there may be more UEs 704 and more base stations 702.

Still referring to FIG. 7, when the UE 704 obtains a location estimate using RSTDs, the necessary additional data (e.g., the base stations' 702 locations and relative transmission timing) may be provided to the UE 704 by the location server. In some implementations, a location estimate for the UE 704 may be obtained (e.g., by the UE 704 itself or by the location server) from RSTDs and from other measurements made by the UE 704 (e.g., measurements of signal timing from GPS or other global navigation satellite system (GNSS) satellites). In these implementations, known as hybrid positioning, the RSTD measurements may contribute towards obtaining the UE's 704 location estimate but may not wholly determine the location estimate.

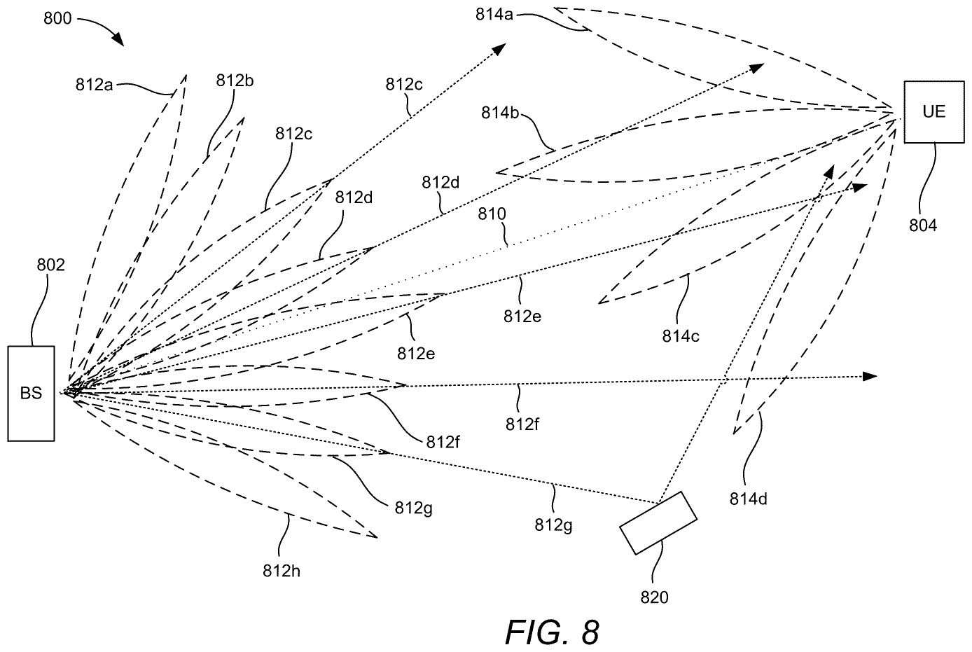

FIG. 8 is a diagram 800 illustrating a base station (BS) 802 (which may correspond to any of the base stations described herein) in communication with a UE 804 (which may correspond to any of the UEs described herein). Referring to FIG. 8, the base station 802 may transmit a beamformed signal to the UE 804 on one or more transmit beams 812a, 812b, 812c, 812d, 812e, 812f, 812g, 812h (collectively, beams 812), each having a beam identifier that can be used by the UE 804 to identify the respective beam. Where the base station 802 is beamforming towards the UE 804 with a single array of antennas (e.g., a single TRP/cell), the base station 802 may perform a “beam sweep” by transmitting first beam 812a, then beam 812b, and so on until lastly transmitting beam 812h. Alternatively, the base station 802 may transmit beams 812 in some pattern, such as beam 812a, then beam 812h, then beam 812b, then beam 812g, and so on. Where the base station 802 is beamforming towards the UE 804 using multiple arrays of antennas (e.g., multiple TRPs/cells), each antenna array may perform a beam sweep of a subset of the beams 812. Alternatively, each of beams 812 may correspond to a single antenna or antenna array.

FIG. 8 further illustrates the paths 812c, 812d, 812e, 812f, and 812g followed by the beamformed signal transmitted on beams 812c, 812d, 812e, 812f, and 812g, respectively. Each path 812c, 812d, 812e, 812f, 812g may correspond to a single “multipath” or, due to the propagation characteristics of RF signals through the environment, may be comprised of a plurality (a cluster) of “multipaths.” Note that although only the paths for beams 812c-812g are shown, this is for simplicity, and the signal transmitted on each of beams 812 will follow some path. In the example shown, the paths 812c, 812d, 812e, and 812f are straight lines, while path 812g reflects off an obstacle 820 (e.g., a building, vehicle, terrain feature, etc.).

The UE 804 may receive the beamformed signal from the base station 802 on one or more receive beams 814a, 814b, 814c, 814d (collectively, beams 814). Note that for simplicity, the beams illustrated in FIG. 8 represent either transmit beams or receive beams, depending on which of the base station 802 and the UE 804 is transmitting and which is receiving. Thus, the UE 804 may also transmit a beamformed signal to the base station 802 on one or more of the beams 814, and the base station 802 may receive the beamformed signal from the UE 804 on one or more of the beams 812.

In an aspect, the base station 802 and the UE 804 may perform beam training to align the transmit and receive beams of the base station 802 and the UE 804. For example, depending on environmental conditions and other factors, the base station 802 and the UE 804 may determine that the best transmit and receive beams are 812d and 814b, respectively, or beams 812e and 814c, respectively. The direction of the best transmit beam for the base station 802 may or may not be the same as the direction of the best receive beam, and likewise, the direction of the best receive beam for the UE 804 may or may not be the same as the direction of the best transmit beam. Note, however, that aligning the transmit and receive beams is not necessary to perform DL-AoD or UL-AoA positioning procedure.

To perform a DL-AoD positioning procedure, the base station 802 may transmit reference signals (e.g., PRS, CRS, TRS, CSI-RS, PSS, SSS, etc.) to the UE 804 on one or more of beams 812, with each beam having a different transmit angle. The different transmit angles of the beams will result in different received signal strengths (e.g., RSRP, RSRQ, SINR, etc.) at the UE 804. Specifically, the received signal strength will be lower for transmit beams 812 that are further from the line-of-sight (LOS) path 810 between the base station 802 and the UE 804 than for transmit beams 812 that are closer to the LOS path 810.

In the example of FIG. 8, if the base station 802 transmits reference signals to the UE 804 on beams 812c, 812d, 812e, 812f, and 812g, then transmit beam 812e is best aligned with the LOS path 810, while transmit beams 812c, 812d, 812f, and 812g are not. As such, beam 812e is likely to have a higher received signal strength at the UE 804 than beams 812c, 812d, 812f, and 812g. Note that the reference signals transmitted on some beams (e.g., beams 812c and/or 812f) may not reach the UE 804, or energy reaching the UE 804 from these beams may be so low that the energy may not be detectable or at least can be ignored.

The UE 804 can report the received signal strength, and optionally, the associated measurement quality, of each measured transmit beam 812c-812g to the base station 802, or alternatively, the identity of the transmit beam having the highest received signal strength (beam 812e in the example of FIG. 8). Alternatively or additionally, if the UE 804 is also engaged in a RTT or TDOA positioning session with at least one base station 802 or a plurality of base stations 812, respectively, the UE 804 can report reception-to-transmission (Rx-Tx) time difference or RSTD measurements (and optionally the associated measurement qualities), respectively, to the serving base station 802 or other positioning entity. In any case, the positioning entity (e.g., the base station 802, a location server, a third-party client, UE 804, etc.) can estimate the angle from the base station 802 to the UE 804 as the AoD of the transmit beam having the highest received signal strength at the UE 804, here, transmit beam 812e.

In one aspect of DL-AoD-based positioning, where there is only one involved base station 802, the base station 802 and the UE 804 can perform a RTT procedure to determine the distance between the base station 802 and the UE 804. Thus, the positioning entity can determine both the direction to the UE 804 (using DL-AoD positioning) and the distance to the UE 804 (using RTT positioning) to estimate the location of the UE 804. Note that the AoD of the transmit beam having the highest received signal strength does not necessarily lie along the LOS path 810, as shown in FIG. 8. However, for DL-AoD-based positioning purposes, it is assumed to do so.

In another aspect of DL-AoD-based positioning, where there are multiple involved base stations 812, each involved base station 802 can report, to the serving base station 802, the determined AoD from the respective base station 802 to the UE 804, or the RSRP measurements. The serving base station 802 may then report the AoDs or RSRP measurements from the other involved base station(s) 812 to the positioning entity (e.g., UE 804 for UE-based positioning or a location server for UE-assisted positioning). With this information, and knowledge of the base stations' 812 geographic locations, the positioning entity can estimate a location of the UE 804 as the intersection of the determined AoDs. There should be at least two involved base stations 812 for a two-dimensional (2D) location solution, but as will be appreciated, the more base stations 812 that are involved in the positioning procedure, the more accurate the estimated location of the UE 804 will be.

To perform an UL-AoA positioning procedure, the UE 804 transmits uplink reference signals (e.g., UL-PRS, SRS, DMRS, etc.) to the base station 802 on one or more of uplink transmit beams 814. The base station 802 receives the uplink reference signals on one or more of uplink receive beams 812. The base station 802 determines the angle of the best receive beams 812 used to receive the one or more reference signals from the UE 804 as the AoA from the UE 804 to itself. Specifically, each of the receive beams 812 will result in a different received signal strength (e.g., RSRP, RSRQ, SINR, etc.) of the one or more reference signals at the base station 802. Further, the channel impulse response of the one or more reference signals will be smaller for receive beams 812 that are further from the actual LOS path between the base station 802 and the UE 804 than for receive beams 812 that are closer to the LOS path. Likewise, the received signal strength will be lower for receive beams 812 that are further from the LOS path than for receive beams 812 that are closer to the LOS path. As such, the base station 802 identifies the receive beam 812 that results in the highest received signal strength and, optionally, the strongest channel impulse response, and estimates the angle from itself to the UE 804 as the AoA of that receive beam 812. Note that as with DL-AoD-based positioning, the AoA of the receive beam 812 resulting in the highest received signal strength (and strongest channel impulse response if measured) does not necessarily lie along the LOS path 810. However, for UL-AoA-based positioning purposes in FR2, it may be assumed to do so.

Note that while the UE 804 is illustrated as being capable of beamforming, this is not necessary for DL-AoD and UL-AoA positioning procedures. Rather, the UE 804 may receive and transmit on an omni-directional antenna.

Where the UE 804 is estimating its location (i.e., the UE is the positioning entity), it needs to obtain the geographic location of the base station 802. The UE 804 may obtain the location from, for example, the base station 802 itself or a location server (e.g., location server 230, LMF 270, SLP 272). With the knowledge of the distance to the base station 802 (based on the RTT or TA), the angle between the base station 802 and the UE 804 (based on the UL-AoA of the best receive beam 812), and the known geographic location of the base station 802, the UE 804 can estimate its location.

Alternatively, where a positioning entity, such as the base station 802 or a location server, is estimating the location of the UE 804, the base station 802 reports the AoA of the receive beam 812 resulting in the highest received signal strength (and optionally strongest channel impulse response) of the reference signals received from the UE 804, or all received signal strengths and channel impulse responses for all receive beams 812 (which allows the positioning entity to determine the best receive beam 812). The base station 802 may additionally report the Rx-Tx time difference to the UE 804. The positioning entity can then estimate the location of the UE 804 based on the UE's 814 distance to the base station 802, the AoA of the identified receive beam 812, and the known geographic location of the base station 802.

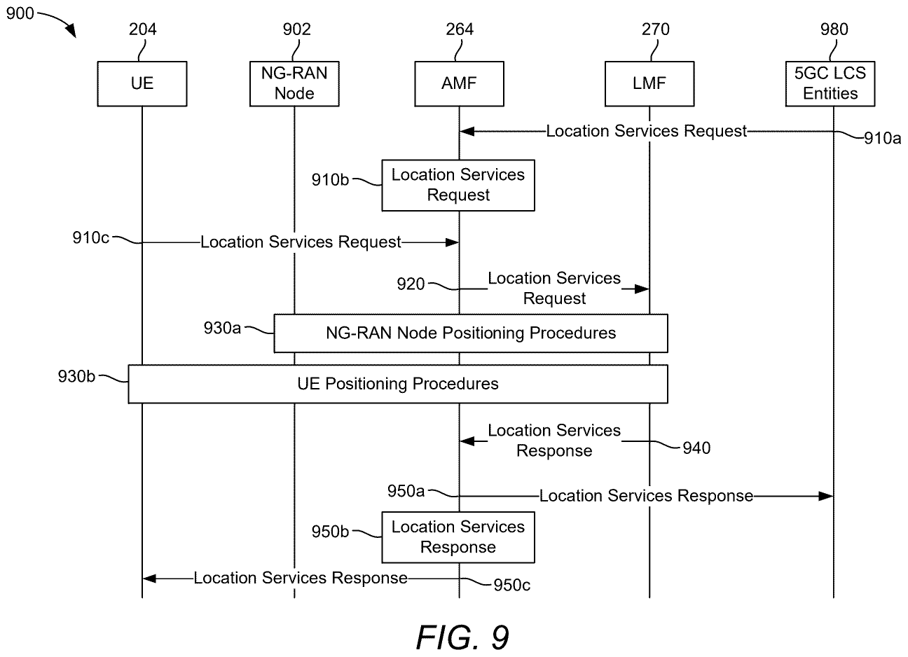

FIG. 9 illustrates example network node location service procedures 900, according to aspects of the disclosure. In this example, the network node that is the target device for the location service procedures is UE 204. The network node location service procedures 900 may be performed by a UE 204, an NG-RAN node 902 (e.g., gNB 222, gNB-CU 226, ng-eNB 224, or other node in the NG-RAN 220) in the NG-RAN 220, an AMF 264, an LMF 270, and a 5GC location services (LCS) entity 980 (e.g., any third-party application requesting the UE's 204 location, a PSAP, an E-911 server, etc.).

A location services request to obtain the location of a target (i.e., UE 204) may be initiated by a 5GC LCS entity 980, the AMF 264 serving the UE 204, or the UE 204 itself. FIG. 9 illustrates these options as stages 910a, 910b, and 910c, respectively. Specifically, at stage 910a, a 5GC LCS entity 980 sends a location services request to the AMF 264. Alternatively, at stage 910b, the AMF 264 generates a location services request itself. Alternatively, at stage 910c, the UE 204 sends a location services request to the AMF 264.

Once the AMF 264 has received (or generated) a location services request, it forwards the location services request to the LMF 270 at stage 920. The LMF 270 then performs NG-RAN positioning procedures with the NG-RAN node 902 at stage 930a and UE positioning procedures with the UE 204 at stage 930b. The specific NG-RAN positioning procedures and UE positioning procedures may depend on the type(s) of positioning method(s) used to locate the UE 204, which may depend on the capabilities of the UE 204. The positioning method(s) may be downlink-based (e.g., LTE-OTDOA, DL-TDOA, DL-AoD, etc.), uplink-based (e.g., UL-TDOA, UL-AoA, etc.), and/or downlink-and-uplink-based (e.g., LTE/NR E-CID, multi-RTT, etc.), as described above.

The NG-RAN positioning procedures and UE positioning procedures may utilize LPP signaling between the UE 204 and the LMF 270 and LPP type A (LPPa) or New Radio positioning protocol type A (NRPPa) signaling between the NG-RAN node 902 and the LMF 270. LPP is used point-to-point between a location server (e.g., LMF 270) and a UE (e.g., UE 204) in order to obtain location-related measurements or a location estimate or to transfer assistance data. A single LPP session is used to support a single location request (e.g., for a single mobile-terminated location request (MT-LR), mobile-originated location request (MO-LR), or network induced location request (NI-LR)). Multiple LPP sessions can be used between the same endpoints to support multiple different location requests. Each LPP session comprises one or more LPP transactions, with each LPP transaction performing a single operation (e.g., capability exchange, assistance data transfer, location information transfer). LPP transactions are referred to as LPP procedures.

A prerequisite for stage 930 is that an LCS Correlation identifier (ID) and an AMF ID has been passed to the LMF 270 by the serving AMF 264. Both, the LCS Correlation ID and the AMF ID may be represented as a string of characters selected by the AMF 264. The LCS Correlation ID and the AMF ID are provided by the AMF 264 to the LMF 270 in the location services request at stage 920. When the LMF 270 then instigates stage 930, the LMF 270 also includes the LCS Correlation ID for this location session, together with the AMF ID, which indicates the AMF instance serving the UE 204. The LCS Correlation ID is used to ensure that during a positioning session between the LMF 270 and the UE 204, positioning response messages from the UE 204 are returned by the AMF 264 to the correct LMF 270 and carrying an indication (the LCS Correlation ID) that can be recognized by the LMF 270.

Note that the LCS Correlation ID serves as a location session identifier that may be used to identify messages exchanged between the AMF 264 and the LMF 270 for a particular location session for a UE 204, as described in greater detail in 3GPP TS 23.273, which is publicly available and incorporated by reference herein in its entirety. As mentioned above and shown in stage 920, a location session between an AMF 264 and an LMF 270 for a particular UE 204 is instigated by the AMF 264, and the LCS Correlation ID may be used to identify this location session (e.g., may be used by the AMF 264 to identify state information for this location session, etc.).

LPP signaling can be used to request and report measurements related to the following positioning methods: LTE-OTDOA, DL-TDOA, A-GNSS, E-CID, sensor, TBS, WLAN, Bluetooth, DL-AoD, UL-AoA, and multi-RTT. Currently, LPP measurement reports may contain the following measurements: (1) one or more ToA, TDOA, RSTD, or Rx-Tx time difference measurements, (2) one or more AoA and/or AoD measurements (currently only for a base station to report UL-AoA and DL-AoD to the LMF 270), (3) one or more multipath measurements (per-path ToA, RSRP, AoA/AoD), (4) one or more motion states (e.g., walking, driving, etc.) and trajectories (currently only for the UE 204), and (5) one or more report quality indications.

As part of the NG-RAN node positioning procedures (stage 930a) and UE positioning procedures (stage 930b), the LMF 270 may provide LPP assistance data in the form of downlink positioning reference signal (DL-PRS) configuration information to the NG-RAN node 902 and the UE 204 for the selected positioning method(s). Alternatively or additionally, the NG-RAN node 902 may provide DL-PRS and/or uplink PRS (UL-PRS) configuration information to the UE 204 for the selected positioning method(s). Note that while FIG. 9 illustrates a single NG-RAN node 902, there may be multiple NG-RAN nodes 902 involved in the positioning session.

Once configured with the DL-PRS and/or UL-PRS configurations, the NG-RAN node 902 and the UE 204 transmit and receive/measure the respective PRS at the scheduled times. The NG-RAN node 902 and the UE 204 then send their respective measurements to the LMF 270. In some cases, the NG-RAN node 902 may send its measurements to the UE 204, which may forward them to the LMF 270 using LPP signaling. Alternatively, the NG-RAN node 902 may send its measurements directly to the LMF 270 in LPPa or NRPPa signaling. In some cases, the UE 204 may send its measurements to the NG-RAN node 902 in RRC, uplink control information (UCI), or MAC control element (MAC-CE) signaling, and the NG-RAN node 902 may forward the measurements to the LMF 270 using LPPa or NRPPa signaling. Alternatively, the UE 204 may send its measurements directly to the LMF 270 using LPP signaling.

Once the LMF 270 obtains the measurements from the UE 204 and/or the NG-RAN node 902 (depending on the type(s) of positioning method(s)), it calculates an estimate of the UE's 204 location using those measurements. Then, at stage 940, the LMF 270 sends a location services response, which includes the location estimate for the UE 204, to the AMF 264. The AMF 264 then forwards the location services response to the entity that generated the location services request at stage 950. Specifically, if the location services request was received from a 5GC LCS entity 980 at stage 910a, then at stage 950a, the AMF 264 sends a location services response to the 5GC LCS entity 980. If, however, the location services request was received from the UE 204 at stage 910c, then at stage 950c, the AMF 264 sends a location services response to the UE 204. Or, if the AMF 264 generated the location services request at stage 910b, then at stage 950b, the AMF 264 stores/uses the location services response itself.

Note that although the foregoing has described the network node location service procedures 900 as a UE-assisted positioning operation, it may instead be a UE-based positioning operation. A UE-assisted positioning operation is one where the LMF 270 calculates the location of the UE 204, whereas a UE-based positioning operation is one where the UE 204 calculates its own location. In the case of a UE-based positioning operation, stages 910c and 950c would be performed. The LMF 270 may still coordinate the transmission/measurement of DL-PRS (and possibly UL-PRS), but the measurements would be forwarded to the UE 204 rather than the LMF 270. As such, the location services response at stages 940 and 950c may be the measurements from the involved NG-RAN node(s) 902 rather than a location estimate of the UE 204. Alternatively, where the involved NG-RAN node(s) 902 forward their respective measurements directly to the UE 204 (e.g., via RRC signaling), the location services response at stage 940 may simply be a confirmation that the NG-RAN node and UE positioning procedures at stage 930 are complete.

NR positioning operations have security vulnerabilities and may be subject to several PRS attack scenarios. In one PRS attack scenario, the PRS attacker has knowledge of a previous PRS sequence used in the positioning operations. The PRS attacker receives one or more PRS symbols, determines transmission parameters, and transmits a new signal for a subsequent PRS. Instead of measuring the PRS transmitted from the correct PRS source, a base station or UE measures the PRS transmitted by the PRS attacker, thereby generating measurements that result in erroneous positioning determinations.

In another PRS attack scenario, the PRS attacker receives the complete PRS configuration through broadcast assistance data or unicast RRC. The PRS attacker transmits PRS based on the information obtained from the complete PRS configuration. Again, instead of measuring the PRS transmitted from the correct PRS source, a base station or UE measures the PRS transmitted by the PRS attacker, thereby generating measurements that result in erroneous positioning determinations.

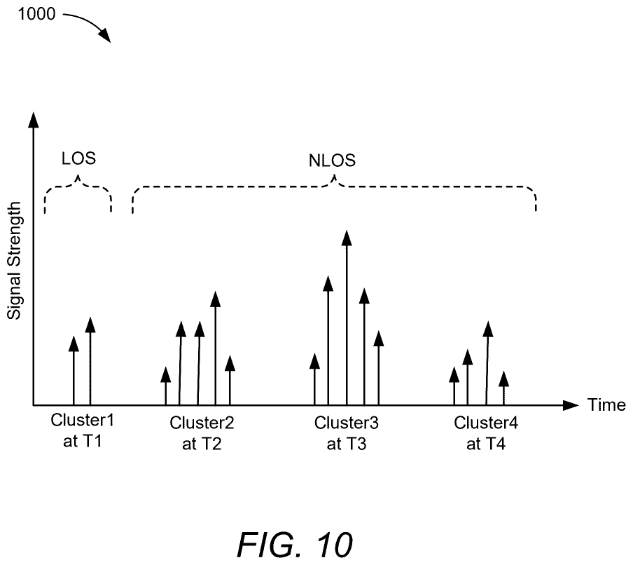

In accordance with certain aspects of the disclosure, certain characteristics of the received PRS may be used to distinguish between PRS transmitted by an authentic TRP and PRS transmitted by a PRS attacker. In an aspect, a UE or base station (one or both of which are referred to herein as “receiving entities”) may check for the time domain consistency of the PRS and/or SRS. One manner of checking time domain consistency involves monitoring channel impulse (energy) responses (CER). Generally stated, FIG. 10 is a graph 1000 representing the channel impulse (energy) response of a multipath channel between a receiver device (e.g., any of the UEs or base stations described herein) and a transmitter device (e.g., any other of the UEs or base stations described herein), according to aspects of the disclosure. The channel impulse response represents the intensity of a RF signal received through a multipath channel as a function of time delay. Thus, the horizontal axis is in units of time (e.g., milliseconds) and the vertical axis is in units of signal strength (e.g., decibels). Note that a multipath channel is a channel between a transmitter and a receiver over which an RF signal follows multiple paths, or multipaths, due to transmission of the RF signal on multiple beams and/or to the propagation characteristics of the RF signal (e.g., reflection, refraction, etc.).

In the example of FIG. 10, the receiver detects/measures multiple (four) clusters of channel taps. Each channel tap represents a multipath that an RF signal followed between the transmitter and the receiver and, in some instances, an RF signal transmitted by an attacker. That is, a channel tap represents the arrival of an RF signal on a multipath and/or from an attacker. Each cluster of channel taps indicates that the corresponding multipaths followed essentially the same path. There may be different clusters due to 1) the RF signal being transmitted on different transmit beams (and therefore at different angles), 2) the propagation characteristics of RF signals (e.g., potentially following different paths due to reflections), 3) the RF signal being transmitted by an attacker, or 4) any combination thereof.

All of the clusters of channel taps for a given RF signal represent the multipath channel (or simply channel) between the transmitter and receiver. Under the channel illustrated in FIG. 10, the receiver receives a first cluster of two RF signals on channel taps at time T1, a second cluster of five RF signals on channel taps at time T2, a third cluster of five RF signals on channel taps at time T3, and a fourth cluster of four RF signals on channel taps at time T4. In the example of FIG. 10, because the first cluster of RF signals at time T1 arrives first, it is assumed to correspond to the RF signal transmitted on the transmit beam aligned with the LOS, or the shortest, path. The third cluster at time T3 is comprised of the strongest RF signals, and may correspond to, for example, the RF signal transmitted on a transmit beam aligned with a non-line-of-sight (NLOS) path. Note that although FIG. 10 illustrates clusters of two to five channel taps, as will be appreciated, the clusters may have more or fewer than the illustrated number of channel taps.

In an aspect of PRS attacker detection, the receiving entity checks consistency of the CER across multiple PRS and/or SRS (both of which are designated hereinafter as “PRS”) repetitions. To this end, the receiving entity may combine a number N of PRS symbols of each PRS resource and estimate the ToA through CER peak detection. The receiving entity may check for time domain consistency across different resource repetitions. The time domain consistency detection may include peak location consistency, power delay profile (a.k.a, CER) consistency, etc. If such time domain parameters are inconsistent, certain PRS and/or SRS (referenced subsequently herein as “PRS”) measured in the channel may be originating from a source other than an authentic TRP and may include PRS transmitted by a PRS attacker.

In another aspect, the receiving entity may check the consistency of CER across each PRS symbol within a PRS resource. To this end, the receiving entity may estimate the CERs with each PRS symbol within a PRS resource. For a comb pattern of N PRS resources, the receiving entity should expect N CER peaks. The receiving entity could check the time domain consistency across different PRS symbols. The time domain consistency detection may include peak location consistency, power delay profile consistency, etc. Again, if such measurements are inconsistent, certain of the measured PRS may be originating from a source other than an authentic TRP and may include PRS transmitted by a PRS attacker.

In another aspect, the receiving entity may compare CER across PRS symbols and/or PRS resources with other communication reference signal (RS) symbols and/or resources. For security purposes, the PRS may be QCLed with some unicast communication RS (e.g., TRS, CSI-RS, DMRS). The receiving entity may compare the CER estimated from the PRS and their associated unicast communication RS. If the receiving entity observes time domain inconsistency of CERs, the receiving entity may classify the received PRS as a PRS attack event.

In accordance with certain aspects of the disclosure, the receiving entity may receive RSTD assistance data for PRS processing from a base station and/or a location server. In an aspect, the receiving entity may be provided with expected RSTD measurement values together with corresponding value uncertainties (e.g., search windows) for the TRPs in the assistance data that are to be measured by the receiving entity. As an example, the value range for the uncertainty of the expected RSTD when any of the resources used for the DL positioning measurement are in FR1 may be +/−32 us, in accordance with certain aspects. When all of the resources used for the DL positioning measurement are in FR2, the value range for the uncertainty of the expected RSTD may be about +/−8 us, in accordance with certain aspects.

A receiving entity may also monitor PRS for angle-domain consistency to detect transmissions of a PRS attacker. In an aspect, the receiving entity may be capable of estimating the AoA for each PRS through digital beamforming. A receiving entity, such as a UE, could also get its own location either through previous NR positioning fix and/or non-RAT positioning methods, such as a GNSS. Still further, the UE may be able to get the location of the base station (e.g., gNB) or other TRP location through the assistance data to estimate the AoA. Based on such estimations, UE may check the angle-domain consistency across different PRS symbols and/or PRS resources. For example, the receiving entity may check the difference between the AoA of the PRS as estimated based on the known TRP location and measurement of the AoA as determined from measurements of the actual PRS transmission to determine angle consistency. In an aspect, the receiving entity may compare the estimated angle with one or more previous angle measurements of one or more recently received PRS. In various aspects, the estimated angle may be determined from RAT dependent technology, RAT independent technology, or any combination thereof. In an aspect, the receiving entity may check the angle estimation consistency across multiple PRS symbols and resources. If the receiving entity observes angle-domain inconsistency of the PRS, the receiving entity may classify the received PRS as a PRS attack event.

In certain aspects, angle-domain consistency may be combined with time domain consistency checks to deal with situations in which the PRS attacker is located along the propagation path between the receiving entities (e.g., between the gNB and UE). Also, such a combination is advantageous where the PRS attacker obtains a rough estimate of the location of the victim receiving entity and uses that rough estimate in determining the timing of the transmission of the attacking PRS.

In accordance with certain aspects of the disclosure, a receiving entity, such as a UE, may receive angle assistance data (e.g., expected AoA, expected AoD, the expected zenith-of-departure (ZoD), the expected zenith-of-arrival (ZoA), or other expected angular measurements, any of which may be referred to as an “expected angular measurement”) from a base station, a location server, or any combination thereof. In an aspect, the ULE may be provided with expected angular measurement values together with corresponding expected angular measurement uncertainties for the TRPs indicated in the assistance data. In an aspect, a single expected angular measurement value (e.g., AoD and/or ZoD) and corresponding uncertainty range for the expected angular measurement value can be provided to the UE for each TRP that the UE is to measure during a positioning session. In an aspect, indications of multiple expected angular measurement values (e.g. AoD and/or ZoD) and corresponding uncertainty ranges may be signaled to the UE by the location server, base station, or any combination thereof.

Additionally, or in the alternative, a receiving entity, such as a base station, may be provided with one or more AoAs and/or ZoAs for UL-PRS (e.g., SRS) transmitted by UEs that are to be measured by the base station during a positioning session. In an aspect, a single expected AoA value and/or ZoA value and a corresponding range of uncertainty for each AoA value and/or ZoA value can be provided to the base station for each UE. Additionally, or in the alternative, the base station may receive multiple expected AoA values and/or ZoA values and corresponding ranges of uncertainty for each of the multiple expected AoA values and/or ZoA values for each UE. In an aspect, the base station may receive the expected angular measurement values and corresponding range of uncertainty values from a location server. Additionally, or in the alternative, the base station may estimate the expected angular measurement values and the corresponding range of uncertainty values on its own based on prior UL-PRS (e.g., SRS) transmissions of the UEs that have been measured by the base station during a previous positioning session.

In an aspect, the receiving entity does not receive expected angular measurements and corresponding uncertainties. For example, expected angular measurements and corresponding uncertainties need not be transmitted to the receiving entity if solely using time domain consistency for PRS attacker detection.

In accordance with aspects of the disclosure, positioning sessions using expected angular and/or time domain measurement values and corresponding uncertainty values may be secured by hashing such values to reduce the risk that a PRS attacker may intercept and use such values in a PRS attack. To this end, the entity transmitting such estimated and/or uncertainty values may execute a hashing function on the values before transmitting them to one or more receiving entities. In turn, the receiving entities may execute the same hashing functions on actual measurements that the receiving entity makes during the positioning session. The receiving entities may compare the hashed values of the expected measurements, expected uncertainties, and actual measurements to determine whether the actual measurements are consistent with the expected measurements. In an aspect, whether the actual measurements are consistent with the expected measurements can be determined by determining whether the hashed values of the expected measurements with the hashed values of the actual measurements are within ranges of expected measurement uncertainties as reflected in the hashed values of the expected measurement uncertainties.

A hash function is a mathematical function that converts a numerical input value into another compressed numerical value. The input to the hash function may be of arbitrary length but the output is of a fixed length. In order to be an effective cryptographic tool, it is desirable that the hash function possess certain properties. For instance, the hash function should have a degree of pre-image resistance in that it should be computationally hard to reverse the hash function. In other words, if a hash function h is applied to an input value x and produces a hashed value z, then it should be difficult process to find the input value x that from the hashed value z. This property protects against an attacker who only has a hashed value z from determining the input value x.

Another desirable feature for a hash function is that it possesses a secondary pre-image resistance property in that given an input x and its hash z, it should be hard to find a different input that generates the same hash. In other words, if a hash function h for an input x produces hashed value h(x), then it should be difficult to find any other input value y such that h(y)=h(x). This property of the hash function protects against an attacker who has an input value and its hash and wants to substitute different value as legitimate value in place of the original input value.

A still further desirable feature for a hash function is that it possesses collision resistance properties. This property means it should be hard to find two different inputs of any length that result in the same hash. This property is also referred to as a collision-free hash function. In other words, for a hash function h, it is hard to find any two different inputs x and y such that h(x)=h(y). Since a hash function is effectively a compression function with a fixed hash length, it is typically not possible for a hash function to avoid all collisions. This collision resistance property of the hash function only means that such collisions should occur infrequently. This property makes it very difficult for an attacker to find two input values with the same hash.

The foregoing desirable properties of hash functions can be used to secure the expected measurement/uncertainty values from use by a PRS attacker. Using hashed values of the expected measurement/uncertainty values helps the receiving entity to assess the authenticity of such hashed values since a PRS attacker cannot alter such hashed values in a manner in which the alteration goes undetected, and the expected/uncertainty values cannot individually or collectively be obtained from the hashed values transmitted to the receiving entity.

To further secure the transmission of the expected quantities, the hashed values of each of these quantities and/or single hashed value for all of the quantities after putting all the quantities in a single stream may be signaled to the receiving entities in one or more secured layers (e.g., Layer 3 data, such as RRC data). As such, even if the security of the RRC transmission is broken, the expected and corresponding uncertainty information associated with each PRS will not be compromised since the hashed value(s) of the quantities remains secured by the hash function. As such, the receiving entity can discard the PRS of unauthorized sources (e.g., PRS attackers) if the hashed values for the quantities it receives for the expected measurements and/or corresponding range of uncertainty do not make sense (e.g., the hashed values do not fall within ranges of values that the receiving entity expects to receive under the circumstances of the positioning session).

To maintain the integrity and authentication of the positioning measurements, the entity transmitting the hashed expected values/uncertainties can signal hashed values including, for example, 1) one or more expected PRS reference signal received power (PRS-RSRP) measurement values, 2) one or more PRS-RSRP uncertainty values associated with the one or more expected PRS-RSRP measurement values, 3) one or more expected RSTD measurement values, 4) one or more RSTD uncertainty values associated with the expected one or more RSTD measurement values, 5) one or more expected AoA measurement values, 6) one or more AoA uncertainty values associated with the one or more AoA measurement values, 7) one or more expected AoD measurement values, 8) one or more AoD uncertainty values associated with the one or more AoD measurement values, 9) one or more expected ZoA measurement values, 10) one or more ZoA uncertainty values associated with the one or more ZoA measurement values, 11) one or more expected ZoD measurement values, 12) one or more ZoD uncertainty values associated with the one or more ZoD measurement values, or 13) any combination thereof.

In accordance with certain aspects of the disclosure, a receiving entity, such as a UE, receives a configuration of one or more in resources of one or more TRPs that are to be to be measured during a positioning session. The UE further receives a first set of one or more hashed values that are based on one or more hashing operations applied to one or more expected measurement values and/or corresponding expected uncertainty values, such as the expected measurement values and expected uncertainty values described herein. The hashed values of the expected measurement values and/or corresponding expected uncertainty values are generated, for example, by a location server and/or base station (e.g., gNB). In an aspect, the expected measurement values and expected uncertainty values are determined at the location server and/or base station. In an aspect, expected measurement values and/or expected uncertainty values are generated for each time and/angular measurement of the PRS resources that are to be measured by the UE and used for PRS attacker detection. Prior to transmission to the UE, the location server and/or base station applies one or more hash functions to the expected measurement and/or expected uncertainty values.

In an aspect, the one or more hash functions may be individually applied to each expected measurement value and/or expected uncertainty value of each PRS resource that is to be measured by the UE and used for PRS attacker detection. In an aspect, the same hash function may be applied to each such individual expected measurement value and/or expected uncertainty value. In an aspect, different hash functions may be applied to different ones of the individual expected measurement value and/or uncertainty value. The hash functions and how they are applied to the expected measurement values and/or uncertainty values are agreed upon between the UE and the location server and/or base station.

In an aspect, a hash function may be applied to multiple expected measurement values and/or expected uncertainty values. For example, one or more strings of multiple expected measurement values and/or corresponding uncertainty values may be generated at the location server and/or base station based on a string generation methodology agreed upon by the UE and the location server and/or base station. In turn, the location server and/or base station applies one or more hash functions to the strings to generate the hashed values, where the one or more hash functions are agreed upon by the UE and the location server and/or base station. In an aspect, the same hash function may be applied to each of the multiple string values. In an aspect, different hash functions may be applied to different ones of the multiple string values. Again, the hash functions and the manner in which they are applied to the multiple strings are agreed upon by the UE and the location server and/or base station.

During the positioning session, the UE measures the PRS resources indicated in the received transmission (e.g., assistance data) to generate actual measurement values for the PRS resources. Based on whether the measurement of a PRS resource is to be used for PRS attacker detection, the UE uses the actual measurement values to generate one or more corresponding hashed values in a manner agreed upon between the UE and the location server and/or base station. As a result, the UE now has hashed values (e.g., a second set of one or more hashed values) corresponding to one or more actual measurement values of the PRS resources that may be used for PRS attacker detection.

Once the UE has generated the second set of hashed values, the UE compares the second set of one or more hashed values to the first set of one or more hashed values to detect a PRS attack. In an aspect, a comparison is used to determine whether the one or more actual measurement values are within acceptable limits of the one or more expected measurement values. In an aspect, the comparison includes comparing the second set of one or more hashed values with the first set of one or more hashed values to determine whether at least one actual measurement value of the one or more actual measurement values is outside the acceptable limits of at least one expected measurement value of the one or more expected measurement values.

If detected, the UE may report, to the location server and/or base station, error information relating to the actual measurement value for which the corresponding hashed value falls outside the acceptable limits. The error information may indicate which actual measurements the UE as determined fall outside of the acceptable limits. In an aspect, the error information may include a bit map that indicates which parameters (e.g., RSRP, RSTD, AoD, ZoD, etc.) of the actual PRS resource measurement fall outside of the acceptable limits. In an aspect, individual bits of the bit map may correspond to a respective parameter (e.g., bit 3 corresponds to RSRP, bit 2 corresponds to RSTD, bit 1 corresponds to AoD, and bit 0 corresponds to ZoD). Using this bit correspondence as an example, a bit map of 1010 indicates that the measured RSRP and AoD values are outside acceptable limits while the RSTD and ZoD are within acceptable limits. It will be recognized, based on the teachings of the present disclosure, that other bit mappings to various parameters may be used, the foregoing constituting one such example.

Additionally, or in the alternative, the error information may indicate a degree to which the actual measurement is outside the acceptable limits. In an aspect, the degree may be expressed as a difference between the hashed value of the expected measurement value and the hashed value of the actual measurement value. Additionally, or in the alternative, the degree may be expressed in accordance with a calculation agreed upon by the UE and the location server and/or base station.

In accordance with certain aspects of the disclosure, a determination of a range of acceptable limits used for comparison of a hashed value of an expected measurement value with a hashed value of the actual measurement value may be based on the expected uncertainty value associated with the expected measurement value. In accordance with certain aspects, the expected measurement value of a PRS resource that is to be measured by the UE may be hashed with the corresponding expected uncertainty value to generate a hashed value that is used for the comparison. In accordance with certain aspects, multiple expected measurement values associated with a PRS resource that is to be measured by the UE may be hashed and sent to the UE by the location server and/or base station as a basis for the comparison. In accordance with certain aspects, the multiple expected uncertainty values associated with a PRS resource that is to be measured by the UE may be hashed and sent to the UE by the location server and/or base station for use in the comparison. Additionally, or in the alternative, the range of acceptable limits may be based on another range agreed upon by the UE and the location server and/or base station. In such instances, the agreed-upon range may be expressed as a fixed value for the range of acceptable limits or a hashed value corresponding to the range of acceptable limits.

In accordance with certain aspects of the disclosure, the UE and a location server and/or base station may agree upon a hash bin configuration that is used for the comparison. In an aspect, the hash bin configuration may be based on hashed values that fall within the range of acceptable limits of the hashed values generated using the expected measurement values and/or the expected uncertainty values. Additionally, or in the alternative, the hash bin configuration may include hash bins that correspond to hashed values that are outside of the range of acceptable limits.

In accordance with certain aspects of the disclosure, a single hash bin configuration may be associated with each given expected measurement value to be measured by the UE. Additionally, or in the alternative, in instances in which a hashed value corresponds to a set of multiple expected measurement values, a single hash bin configuration may be associated with each set.

In certain aspects of the disclosure, each hash bin of the hash bin configuration may correspond to a range of hashed values. Such a hash bin configuration may be implemented when the hash functions used to generate the hashed values are locality-sensitive hash functions. Locality-sensitive hashing is an algorithmic technique that hashes similar input items into the same “buckets” (e.g., a bin corresponding to a range of hashed values) with high probability. Since similar hashed values end up in the same buckets, this technique can be used for data clustering and nearest neighbor search to determine whether a hashed value corresponding to one or more actual measurement values is within acceptable limits of hashed values corresponding to one or more expected measurement values. In such instances, depending on its implementation, the number of hash collisions associated with a locality-sensitive hashing function may be greater than the number of hash collisions resulting from other types of hashing functions. In certain aspects, regardless of whether or not the hash function used is locality-sensitive, the ability to detect a PRS attack may be increased by increasing the number of hash bins used in the configuration.

Since there could be error in measurements without a PRS attack, the UE can compare the hashed values of the current hash bin, current hash bin +Y, current hash bin −X, or a defined hash bin set with the received hashed value for each parameter, where X and Y are RRC/MAC-CE configured and correspond to the number of adjacent bins to the current hash bin. If there is a mismatch in one or more quantities (e.g., per configuration between the UE and the location server and/or base station), the UE reports the occurrence. In an aspect, the occurrence may be indicated in a flag or other information of a report that is dedicated to PRS attack detection. Additionally, or in the alternative, the occurrence may be indicated by a flag or other information in a report with other information reported by the UE, where the other information is provided in a report that is not dedicated to PRS attack detection.

In accordance with certain aspects of the disclosure, a UE may attempt to assign the hashed values corresponding to the actual measurement values to the hash bins of the hash bin configuration. As an example, the UE may execute an assignment operation to assign one or more hashed values of the second set of hashed values to one or more hash bins of the agreed-upon hash bin configuration. In aspects, the UE may report, to the location server and/or base station, information relating to one or more hashed values of the second set of hashed values that are not assignable to an allowed hashed bin of the set of hashed bins and/or one or more hashed values falling within hash bins corresponding to hashed values indicating a PRS attack.

As noted, hashed values may be generated using individual expected measurement values. In such instances, the first set of one or more hashed values may include a hashed value of fixed size L respectively associated with each of the one or more expected measurement values. Accordingly, the second set of one or more hashed values may include a hashed value of fixed size L respectively associated with each of the one or more actual measurement values. In certain aspects, the value of L may be selected based on the desired accuracy of a PRS attack determination. In certain aspects, the value of L may be selected based on a tolerable hash collision factor. The value of L may be RRC/MAC-CE configured or based upon a specification agreed upon between the UE and the location server and/or base station. Other factors for determining the value of L may also be used.

Additionally, or in the alternative, the first set of one or more hashed values includes a hashed value of size Z collectively associated with multiple expected measurement values of the one or more expected measurement values. Further, the second set of one or more hashed values may include a hashed value of size Z collectively associated with multiple actual measurement values of the one or more actual measurement values. In certain aspects, the value of Z may be configured via RRC/MAC-CE. Additionally, or in the alternative, the value of Z may be based upon a specification agreed upon between the UE and the location server and/or base station.

In accordance with certain aspects of the disclosure, the value of Z may be based on a Modulation and Coding Scheme (MCS) similar to the Transport Block Size (TBS) computation set forth in 3GPP TS 138.214, which is publicly available. Determining the value of Z in this manner facilitates the generation of dynamic reports. In an aspect, the value of Z may be determined as:

$$Z = {N}_{info} = \# layers * {spectral}_{eff} * \# REs$$

where
#layers is the number of control information layers,
spectral_{eff} is the spectral efficiency, and
#REs is the number of resource elements.

In certain aspects, the value of Z determined based on this calculation may be modified based on the desired accuracy of a PRS attack determination. In certain aspects, the value of Z may be modified based on a tolerable hash collision factor. Other factors for modifying the value of Z may also be used.

The hashed values described herein may be signaled to the receiving entity in various manners. In accordance with certain aspects of the disclosure, the hashed values are signaled via LPP. In a Uu link, the hashed values may be signaled in RRC information in the PDSCH data channel. In a sidelink communication, the hashed values may be signaled in RRC information in the physical sidelink shared channel (PSSCH) data channel. In certain aspects, some of the hashed values may be communicated via RRC/PDSCH, while other hashed values are communicated via RRC/PSSCH. Communicating the hashed values via RRC information is beneficial in that the hashed values are further encrypted as part of the encryption of the RRC data thereby providing a further level of security to the predicted measurement values and/or corresponding uncertainty values.

In accordance with certain aspects of the disclosure, the hashed values are signaled via RRC information. In certain aspects, the RRC information is carried in a PDSCH, a PSSCH, or a combination thereof.

In certain instances, encryption/decryption of the hashed expected value/uncertainties and/or hashed actual measurement values in an RRC transmission may be slow, particularly for mobile UEs. To address such time constraints, the hashed expected values/uncertainties and/or hashed actual measurement values may be transmitted in PHY layer signaling to facilitate more efficient communication of such hashed values. In certain aspects, PHY layer carriers may be employed are dedicated to transmitting the hashed expected values/uncertainties and/or hashed actual measurement values. In certain aspects, a UE and a base station (e.g., gNB) may exchange the hashed expected values/uncertainties and/or hashed actual measurement values using such PHY layer signaling. In certain aspects, the base station communicates with the location server via NRPPa to receive and/or forward the hashed expected values/uncertainties and/or hashed actual measurements values.

In accordance with certain aspects of the disclosure, the hashed values may be signaled without further encryption. In certain aspects, the hashed values may be signaled via one or more MAC-CEs carried in the PDCCH, one or more MAC-CEs carried in the physical sidelink control channel (PSCCH), in sidelink control information (e.g., SCI-2 data) carried in the PSCCH, or a combination thereof.

In certain aspects, the secured use of hashed measurements, as disclosed herein, are applicable to transmission and reception of positioning information between various network entities. In certain aspects, the communications may be from abase station (e.g., gNB) to UE, a UE to another UE, a UE to a base station (e.g., gNB), etc.

In certain aspects, if an unsecured channel is used for communicating the hashed values, then a private key may be used to encrypt the hashed values at the device transmitting the hashed values. A public key may be used to decrypt the encrypted hashed values at the receiver side. The public key and private key are generated at the device transmitting the hashed values, and the public key is shared with devices receiving the encrypted hashed values. As such, the private key is used for encryption at the transmitting device, and the public key is used for decryption at the receiving device. Before receiving the encrypted hashed values, an attacker cannot determine or generate the encrypted hashed values because the private key is never shared. If a conventional approach to public/private key use were employed, the public key would be used to encrypt the hashed value. However, since the public key would be known to all devices in the network (unless it was transmitted in a unicast or groupcast to specific trusted devices), an attacker can fake the hashed value.

In certain aspects, a known payload of bits may be added to the hashed value payload before encryption with the private key (e.g., a bit sequence of “1100” may be added to the payload of hashed values). The device receiving the hashed values may decrypt the transmission using the public key and determine whether the known payload of bits (e.g., the bit sequence “1100”) is present. The known sequence of bits added to the hashed value payload of hashed values may be configured (e.g., by a base station) or defined in a specification (e.g., a 3GPP specification). The length of the sequence may be fixed or variable.

In certain aspects, the foregoing public key/private key operations may be extended to hashed values transmitted in a secured channel. The additional layer of encryption may be used to enhance the security of the hashed values transmitted on the secured channels.

Encryption/decryption of the hashed values in the foregoing manner differs from conventional encryption/decryption processes. Among other differences, the public key, in accordance with aspects of the disclosure, may be used for encryption and the private key used for decryption. Further, both the private key and public key are generated by the transmitting device, whereas the receiving side generates the public key and private key in conventional public/private key scenarios.

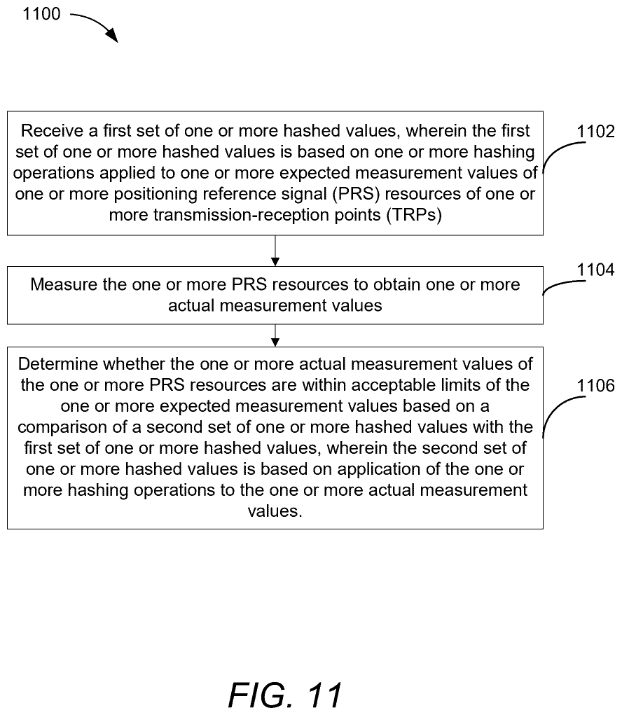

FIG. 11 illustrates an example method 1100 of wireless communication performed by a network node (e.g., UE, gNB, base station, etc.), according to aspects of the disclosure. At operation 1102, the network node receives a first set of one or more hashed values, wherein the first set of one or more hashed values is based on one or more hashing operations applied to one or more expected measurement values of one or more positioning reference signal (PRS) resources of one or more transmission-reception points (TRPs). In an aspect, operation 1102 may be performed by the one or more WWAN transceivers 310, the one or more processors 332, memory 340, and/or positioning component 342, any or all of which may be considered means for performing this operation. In an aspect, operation 1102 may be performed by the one or more WWAN transceivers 350, the one or more processors 384, memory 386, and/or positioning component 388, any or all of which may be considered means for performing this operation.

At operation 1104, the network node measures the one or more PRS resources to obtain one or more actual measurement values. In an aspect, operation 1104 may be performed by the one or more WWAN transceivers 310, the one or more processors 332, memory 340, and/or positioning component 342, any or all of which may be considered means for performing this operation. In an aspect, operation 1104 may be performed by the one or more WWAN transceivers 350, the one or more processors 384, memory 386, and/or positioning component 388, any or all of which may be considered means for performing this operation.

At operation 1106, the network node determines whether the one or more actual measurement values of the one or more PRS resources are within acceptable limits of the one or more expected measurement values based on a comparison of a second set of one or more hashed values with the first set of one or more hashed values, wherein the second set of one or more hashed values is based on application of the one or more hashing operations to the one or more actual measurement values. In an aspect, operation 1106 may be performed by the one or more WWAN transceivers 310, the one or more processors 332, memory 340, and/or positioning component 342, any or all of which may be considered means for performing this operation. In an aspect, operation 1106 may be performed by the one or more WWAN transceivers 350, the one or more processors 384, memory 386, and/or positioning component 388, any or all of which may be considered means for performing this operation.

As will be appreciated, a technical advantage of the method 1100 is that the network node (e.g., UE, gNB, base station, etc.) uses secured hashed values corresponding to the expected measurement values to authenticate the actual PRS measurements that the network node takes during a positioning session while also facilitating an identification of PRS measurements that may be falsified through a PRS attack. Using such secured hashed values for the measurement quantities assists in preventing a PRS attacker from using the expected measurement values in a PRS attack in which the PRS attacker attempts to generate false PRS transmissions.

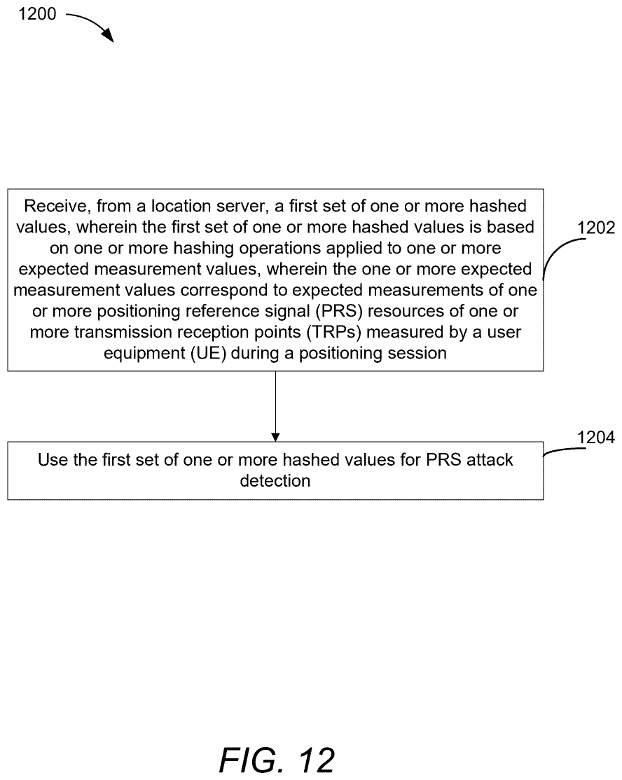

FIG. 12 illustrates an example method 1200 of wireless communication performed by a network node (e.g., UE, gNB, base station, etc.), according to aspects of the disclosure. At operation 1202, the network node receives, from a location server, a first set of one or more hashed values, wherein the first set of one or more hashed values is based on one or more hashing operations applied to one or more expected measurement values, wherein the one or more expected measurement values correspond to expected measurements of one or more positioning reference signal (PRS) resources of one or more transmission-reception points (TRPs) measured by the network node during a positioning session. In an aspect, operation 1202 may be performed by the one or more WWAN transceivers 310, the one or more processors 332, memory 340, and/or positioning component 342, any or all of which may be considered means for performing this operation. In an aspect, operation 1202 may be performed by the one or more WWAN transceivers 350, the one or more processors 384, memory 386, and/or positioning component 388, any or all of which may be considered means for performing this operation.

At operation 1204, the network node uses the first set of one or more hashed values for PRS attack detection. In accordance with certain aspects of the disclosure, the use of the first set of one or more hash values for PRS attack detection includes transmitting the first set of one or more hashed values to the UE, and receiving an indication from the UE that one or more actual measurement values made by the UE are outside of acceptable limits of at least one expected measurement value of the one or more expected measurement values. In accordance with certain aspects of the disclosure, the use of the first set of one or more hash values for PRS attack detection includes receiving a second set of one or more hashed values corresponding to one or more actual measurement values taken by the UE of the one or more PRS resources, and determining whether the one or more actual measurement values of the one or more PRS resources are within acceptable limits of the one or more expected measurement values based on a comparison of a second set of one or more hashed values with the first set of one or more hashed values, wherein the second set of one or more hashed values is based on application of the one or more hashing operations to the one or more actual measurement values. In an aspect, operation 1204 may be performed by the one or more WWAN transceivers 310, the one or more processors 332, memory 340, and/or positioning component 342, any or all of which may be considered means for performing this operation. In an aspect, operation 1204 may be performed by the one or more WWAN transceivers 350, the one or more processors 384, memory 386, and/or positioning component 388, any or all of which may be considered means for performing this operation.

As will be appreciated, a technical advantage of the method 1200 is that the network node uses secured hashed values corresponding to the expected measurement values to detect PRS measurements that may have been falsified through a PRS attack. Using such secured hashed values for the measurement quantities assists in preventing a PRS attacker from using the expected measurement values in a PRS attack in which the PRS attacker attempts to generate false PRS transmissions.

As will be appreciated, a further technical advantage of the method 1200 is that the network node uses the expected measurement values to authenticate the actual PRS measurements that the network node takes during a positioning session while also facilitating an identification of PRS measurements that may be falsified through a PRS attack.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A method of wireless communication performed by a network node, comprising: receiving a first set of one or more hashed values, wherein the first set of one or more hashed values is based on one or more hashing operations applied to one or more expected measurement values of one or more positioning reference signal (PRS) resources of one or more transmission-reception points (TRPs); measuring the one or more PRS resources to obtain one or more actual measurement values; and determining whether the one or more actual measurement values of the one or more PRS resources are within acceptable limits of the one or more expected measurement values based on a comparison of a second set of one or more hashed values with the first set of one or more hashed values, wherein the second set of one or more hashed values is based on application of the one or more hashing operations to the one or more actual measurement values.

Clause 2. The method of clause 1, further comprising: receiving a configuration of the one or more PRS resources of the one or more TRPs to be measured during a positioning session.

Clause 3. The method of any of clauses 1 to 2, further comprising: determining, based on the comparison of the second set of one or more hashed values with the first set of one or more hashed values, that at least one actual measurement value of the one or more actual measurement values is outside the acceptable limits of at least one expected measurement value of the one or more expected measurement values; and reporting error information relating to the at least one actual measurement value of the one or more actual measurement values.

Clause 4. The method of clause 3, wherein: the error information includes a bit map including flags indicating which parameters of the at least one actual measurement value is outside the acceptable limits.

Clause 5. The method of any of clauses 3 to 4, wherein: the error information includes an indication of a degree to which the at least one actual measurement is outside the acceptable limits.

Clause 6. The method of any of clauses 1 to 5, wherein the first set of one or more hashed values is based on application of the one or more hashing operations to: one or more expected PRS reference signal received power (PRS-RSRP) measurement values; one or more PRS-RSRP uncertainty values associated with the one or more expected PRS-RSRP measurement values; one or more expected reference-signal-time-difference (RSTD) measurement values; one or more RSTD uncertainty values associated with the expected one or more RSTD measurement values; one or more expected angle-of-arrival (AoA) measurement values; one or more AoA uncertainty values associated with the one or more AoA measurement values; one or more expected angle-of-departure (AoD) measurement values; one or more AoD uncertainty values associated with the one or more AoD measurement values; one or more expected zenith-of-arrival (ZoA) measurement values; one or more ZoA expected uncertainty values associated with the one or more ZoA measurement values; one or more expected zenith-of-departure (ZoD) measurement values; one or more expected ZoD uncertainty values associated with the one or more ZoD measurement values; or any combination thereof.

Clause 7. The method of any of clauses 1 to 6, wherein the second set of one or more hashed values is based on application of the one or more hashing operations to: one or more actual reference signal received power (RSRP) measurement values; one or more actual relative-signal-time-difference (RSTD) measurement values; one or more actual angle-of-arrival (AoA) measurement values; one or more actual zenith-of-arrival (ZoA) measurement values; one or more actual zenith-of-departure (ZoD) measurement values; or any combination thereof.

Clause 8. The method of any of clauses 1 to 7, wherein: the first set of one or more hashed values includes a hashed value of size L respectively associated with each of the one or more expected measurement values; and the second set of one or more hashed values includes a hashed value of size L respectively associated with each of the one or more actual measurement values.

Clause 9. The method of clause 8, further comprising: receiving a first final hashed value of size L, wherein the first final hashed value is based on all hashed values of the first set of one or more hashed values; and receiving a second final hashed value of size L wherein the second final hashed value is based on all hashed values of the second set of one or more hashed values.

Clause 10. The method of any of clauses 1 to 7, wherein: the first set of one or more hashed values includes a hashed value of size Z collectively associated with multiple expected measurement values of the one or more expected measurement values; and the second set of one or more hashed values includes a hashed value of size Z collectively associated with multiple actual measurement values of the one or more actual measurement values; and Z is based on a transport block size computation determined as Z=#layers*spectraleff*#REs where #layers is a number of control information layers, spectraleff is a spectral efficiency, and #REs is a number of resource elements.

Clause 11. The method of any of clauses 1 to 10, wherein: the first set of one or more hashed values is received using a Long-Term Evolution Positioning Protocol (LPP).

Clause 12. The method of any of clauses 1 to 10, wherein: the network node is a base station; the one or more PRS resources are uplink PRS (UL-PRS) resources; and the second set of one or more hashed values are received from a user equipment (UE).

Clause 13. The method of any of clauses 1 to 10, wherein: the network node is a user equipment (UE); the one or more PRS resources are downlink PRS (DL-PRS) resources; and the first set of one or more hashed values is received from a base station.

Clause 14. The method of any of clauses 1 to 10, wherein: the network node is a first user equipment (UE); the first set of one or more hashed values are received from a second UE; and the one or more PRS resources are sidelink PRS (SL-PRS) resources.

Clause 15. The method of any of clauses 1 to 10, wherein: the network node is a user equipment (UE); and the first set of one or more hashed values is received in radio resource control (RRC) information.

Clause 16. The method of clause 15, wherein: the RRC information is carried in a physical downlink shared channel (PDSCH), a physical sidelink shared channel (PSSCH), or a combination thereof.

Clause 17. The method of any of clauses 1 to 10, wherein: the first set of one or more hashed values is received in one or more medium access control-control elements (MAC-CEs) carried in a physical download control channel PDCCH.

Clause 18. The method of any of clauses 1 to 10, wherein the first set of one or more hashed values is received in: one or more medium access control-control elements (MAC-CEs) carried in a physical sidelink control channel (PSCCH), sidelink control information carried in the PSCCH, or a combination thereof.

Clause 19. The method of any of clauses 1 to 18, wherein the comparison of the second set of hashed values with the first set of hashed values comprises: executing an assignment operation to assign one or more hashed values of the second set of hashed values to a set of hashed bins, wherein the set of hashed bins are based on the first set of hashed values; and reporting information relating to one or more hashed values of the second set of hashed values that are not assignable to an allowed hashed bin of the set of hashed bins.

Clause 20. A method of wireless communication performed by a network node comprising: receiving, from a location server, a first set of one or more hashed values, wherein the first set of one or more hashed values is based on one or more hashing operations applied to one or more expected measurement values, wherein the one or more expected measurement values correspond to expected measurements of one or more positioning reference signal (PRS) resources of one or more transmission-reception points (TRPs) measured by a user equipment (UE) during a positioning session; and using the first set of one or more hashed values for PRS attack detection.

Clause 21. The method of clause 20, wherein using the first set of one or more hashed values for PRS attack detection comprises: transmitting the first set of one or more hashed values to the UE; and receiving an indication from the UE that one or more actual measurement values made by the UE are outside of acceptable limits of one or more expected measurement values.

Clause 22. The method of clause 21, wherein: the indication from the UE includes a bit map including flags indicating which parameters of the one or more actual measurement values are outside the acceptable limits.

Clause 23. The method of any of clauses 21 to 22, wherein: the indication from the UE includes an indication of a degree to which the one or more actual measurement values are outside the acceptable limits.

Clause 24. The method of any of clauses 21 to 23, further comprising: reporting error information, to the location server, relating to the one or more actual measurement values made by the UE that are outside of the acceptable limits of the one or more expected measurement values.

Clause 25. The method of any of clauses 20 to 24, wherein using the first set of one or more hashed values for PRS attack detection comprises: receiving a second set of one or more hashed values corresponding to one or more actual measurement values taken by the UE of the one or more PRS resources; and determining whether the one or more actual measurement values of the one or more PRS resources are within acceptable limits of the one or more expected measurement values based on a comparison of the second set of one or more hashed values with the first set of one or more hashed values, wherein the second set of one or more hashed values is based on application of the one or more hashing operations to the one or more actual measurement values.

Clause 26. The method of clause 25, wherein the second set of one or more hashed values is based on applying the one or more hashing operations to: one or more actual reference signal received power (RSRP) measurement values; one or more expected relative-signal-time-difference (RSTD) measurement values; one or more expected angle-of-arrival (AoA) measurement values; or a combination thereof.

Clause 27. The method of any of clauses 20 to 26, wherein the first set of one or more hashed values is based on application of the one or more hashing operations to: one or more expected PRS reference signal received power (PRS-RSRP) measurement values; one or more expected PRS-RSRP uncertainty values associated with the one or more expected PRS-RSRP measurement values; one or more expected reference-signal-time-difference (RSTD) measurement values; one or more expected RSTD uncertainty values associated with the one or more RSTD measurement values; one or more expected angle-of-arrival (AoA) measurement values; one or more expected AoA uncertainty values associated with the one or more AoA measurement values; one or more expected zenith-of-arrival (ZoA) measurement values; one or more expected ZoA uncertainty values associated with the one or more ZoA measurement values; one or more expected zenith-of-departure (ZoD) measurement values; one or more expected ZoD uncertainty values associated with the one or more ZoD measurement values; or any combination thereof.

Clause 28. A network node, comprising: a memory; at least one transceiver; and at least one processor communicatively coupled to the memory and the at least one transceiver, the at least one processor configured to: receive, via the at least one transceiver, a first set of one or more hashed values, wherein the first set of one or more hashed values is based on one or more hashing operations applied to one or more expected measurement values of one or more positioning reference signal (PRS) resources of one or more transmission-reception points (TRPs); measure the one or more PRS resources to obtain one or more actual measurement values; and determine whether the one or more actual measurement values of the one or more PRS resources are within acceptable limits of the one or more expected measurement values based on a comparison of a second set of one or more hashed values with the first set of one or more hashed values, wherein the second set of one or more hashed values is based on application of the one or more hashing operations to the one or more actual measurement values.

Clause 29. The network node of clause 28, wherein the at least one processor is further configured to: receive, via the at least one transceiver, a configuration of the one or more PRS resources of the one or more TRPs to be measured during a positioning session.

Clause 30. The network node of any of clauses 28 to 29, wherein the at least one processor is further configured to: determine, based on the comparison of the second set of one or more hashed values with the first set of one or more hashed values, that at least one actual measurement value of the one or more actual measurement values is outside the acceptable limits of at least one expected measurement value of the one or more expected measurement values; and report, via the at least one transceiver, error information relating to the at least one actual measurement value of the one or more actual measurement values.

Clause 31. The network node of clause 30, wherein: the error information includes a bit map including flags indicating which parameters of the at least one actual measurement value is outside the acceptable limits.

Clause 32. The network node of any of clauses 30 to 31, wherein: the error information includes an indication of a degree to which the at least one actual measurement is outside the acceptable limits.

Clause 33. The network node of any of clauses 28 to 32, wherein the first set of one or more hashed values is based on application of the one or more hashing operations to: one or more expected PRS reference signal received power (PRS-RSRP) measurement values; one or more PRS-RSRP uncertainty values associated with the one or more expected PRS-RSRP measurement values; one or more expected reference-signal-time-difference (RSTD) measurement values; one or more RSTD uncertainty values associated with the expected one or more RSTD measurement values; one or more expected angle-of-arrival (AoA) measurement values; one or more AoA uncertainty values associated with the one or more AoA measurement values; one or more expected angle-of-departure (AoD) measurement values; one or more AoD uncertainty values associated with the one or more AoD measurement values; one or more expected zenith-of-arrival (ZoA) measurement values; one or more ZoA expected uncertainty values associated with the one or more ZoA measurement values; one or more expected zenith-of-departure (ZoD) measurement values; one or more expected ZoD uncertainty values associated with the one or more ZoD measurement values; or any combination thereof.

Clause 34. The network node of any of clauses 28 to 33, wherein the second set of one or more hashed values is based on application of the one or more hashing operations to: one or more actual reference signal received power (RSRP) measurement values; one or more actual relative-signal-time-difference (RSTD) measurement values; one or more actual angle-of-arrival (AoA) measurement values; one or more actual zenith-of-arrival (ZoA) measurement values; one or more actual zenith-of-departure (ZoD) measurement values; or any combination thereof.

Clause 35. The network node of any of clauses 28 to 34, wherein: the first set of one or more hashed values includes a hashed value of size L respectively associated with each of the one or more expected measurement values; and the second set of one or more hashed values includes a hashed value of size L respectively associated with each of the one or more actual measurement values.

Clause 36. The network node of clause 35, wherein the at least one processor is further configured to: receive, via the at least one transceiver, a first final hashed value of size L, wherein the first final hashed value is based on all hashed values of the first set of one or more hashed values; and receive, via the at least one transceiver, a second final hashed value of size L wherein the second final hashed value is based on all hashed values of the second set of one or more hashed values.

Clause 37. The network node of any of clauses 28 to 34, wherein: the first set of one or more hashed values includes a hashed value of size Z collectively associated with multiple expected measurement values of the one or more expected measurement values; and the second set of one or more hashed values includes a hashed value of size Z collectively associated with multiple actual measurement values of the one or more actual measurement values; and Z is based on a transport block size computation determined as Z=#layers*spectraleff*#REs where #layers is a number of control information layers, spectraleff is a spectral efficiency, and #REs is a number of resource elements.

Clause 38. The network node of any of clauses 28 to 37, wherein: the first set of one or more hashed values is received using a Long-Term Evolution Positioning Protocol (LPP).

Clause 39. The network node of any of clauses 28 to 36, wherein: the network node is a base station; the one or more PRS resources are uplink PRS (UL-PRS) resources; and the second set of one or more hashed values are received from a user equipment (UE).

Clause 40. The network node of any of clauses 28 to 36, wherein: the network node is a user equipment (UE); the one or more PRS resources are downlink PRS (DL-PRS) resources; and the first set of one or more hashed values is received from a base station.

Clause 41. The network node of any of clauses 28 to 38, wherein: the network node is a first user equipment (UE); the first set of one or more hashed values are received from a second UE; and the one or more PRS resources are sidelink PRS (SL-PRS) resources.

Clause 42. The network node of any of clauses 28 to 36, wherein: the network node is a user equipment (UE); and the first set of one or more hashed values is received in radio resource control (RRC) information.

Clause 43. The network node of clause 42, wherein: the RRC information is carried in a physical downlink shared channel (PDSCH), a physical sidelink shared channel (PSSCH), or a combination thereof.

Clause 44. The network node of any of clauses 28 to 36, wherein: the first set of one or more hashed values is received in one or more medium access control-control elements (MAC-CEs) carried in a physical download control channel PDCCH.

Clause 45. The network node of any of clauses 28 to 46, wherein the first set of one or more hashed values is received in: one or more medium access control-control elements (MAC-CEs) carried in a physical sidelink control channel (PSCCH), sidelink control information carried in the PSCCH, or a combination thereof.

Clause 46. The network node of any of clauses 28 to 45, wherein the at least one processor configured to determine whether the one or more actual measurement values of the one or more PRS resources are within acceptable limits of the one or more expected measurement values comprises the at least one processor configured to: execute an assignment operation to assign one or more hashed values of the second set of hashed values to a set of hashed bins, wherein the set of hashed bins are based on the first set of hashed values; and report, via the at least one transceiver, information relating to one or more hashed values of the second set of hashed values that are not assignable to an allowed hashed bin of the set of hashed bins.

Clause 47. A network node, comprising: a memory; at least one transceiver; and at least one processor communicatively coupled to the memory and the at least one transceiver, the at least one processor configured to: receive, via the at least one transceiver, from a location server, a first set of one or more hashed values, wherein the first set of one or more hashed values is based on one or more hashing operations applied to one or more expected measurement values, wherein the one or more expected measurement values correspond to expected measurements of one or more positioning reference signal (PRS) resources of one or more transmission-reception points (TRPs) measured by a user equipment (UE) during a positioning session; and use the first set of one or more hashed values for PRS attack detection.

Clause 48. The network node of clause 47, wherein the at least one processor configured to use the first set of one or more hashed values for PRS attack detection comprises the at least one processor configured to: transmit, via the at least one transceiver, the first set of one or more hashed values to the UE; and receive, via the at least one transceiver, an indication from the UE that one or more actual measurement values made by the UE are outside of acceptable limits of one or more expected measurement values.

Clause 49. The network node of clause 48, wherein: the indication from the UE includes a bit map including flags indicating which parameters of the one or more actual measurement values are outside the acceptable limits.

Clause 50. The network node of any of clauses 48 to 49, wherein: the indication from the UE includes an indication of a degree to which the one or more actual measurement values are outside the acceptable limits.

Clause 51. The network node of any of clauses 48 to 50, wherein the at least one processor is further configured to: report, via the at least one transceiver, error information, to the location server, relating to the one or more actual measurement values made by the UE that are outside of the acceptable limits of the one or more expected measurement values.

Clause 52. The network node of any of clauses 47 to 51, wherein the at least one processor configured to use the first set of one or more hashed values for PRS attack detection comprises the at least one processor configured to: receive, via the at least one transceiver, a second set of one or more hashed values corresponding to one or more actual measurement values taken by the UE of the one or more PRS resources; and determine whether the one or more actual measurement values of the one or more PRS resources are within acceptable limits of the one or more expected measurement values based on a comparison of the second set of one or more hashed values with the first set of one or more hashed values, wherein the second set of one or more hashed values is based on application of the one or more hashing operations to the one or more actual measurement values.

Clause 53. The network node of clause 52, wherein the second set of one or more hashed values is based on applying the one or more hashing operations to: one or more actual reference signal received power (RSRP) measurement values; one or more expected relative-signal-time-difference (RSTD) measurement values; one or more expected angle-of-arrival (AoA) measurement values; or a combination thereof.

Clause 54. The network node of any of clauses 47 to 53, wherein the first set of one or more hashed values is based on application of the one or more hashing operations to: one or more expected PRS reference signal received power (PRS-RSRP) measurement values; one or more expected PRS-RSRP uncertainty values associated with the one or more expected PRS-RSRP measurement values; one or more expected reference-signal-time-difference (RSTD) measurement values; one or more expected RSTD uncertainty values associated with the one or more RSTD measurement values; one or more expected angle-of-arrival (AoA) measurement values; one or more expected AoA uncertainty values associated with the one or more AoA measurement values; one or more expected zenith-of-arrival (ZoA) measurement values; one or more expected ZoA uncertainty values associated with the one or more ZoA measurement values; one or more expected zenith-of-departure (ZoD) measurement values; one or more expected ZoD uncertainty values associated with the one or more ZoD measurement values; or any combination thereof.

Clause 55. A network node, comprising: means for receiving a first set of one or more hashed values, wherein the first set of one or more hashed values is based on one or more hashing operations applied to one or more expected measurement values of one or more positioning reference signal (PRS) resources of one or more transmission-reception points (TRPs); means for measuring the one or more PRS resources to obtain one or more actual measurement values; and means for determining whether the one or more actual measurement values of the one or more PRS resources are within acceptable limits of the one or more expected measurement values based on a comparison of a second set of one or more hashed values with the first set of one or more hashed values, wherein the second set of one or more hashed values is based on application of the one or more hashing operations to the one or more actual measurement values.

Clause 56. The network node of clause 55, further comprising: means for receiving a configuration of the one or more PRS resources of the one or more TRPs to be measured during a positioning session.

Clause 57. The network node of any of clauses 55 to 56, further comprising: means for determining, based on the comparison of the second set of one or more hashed values with the first set of one or more hashed values, that at least one actual measurement value of the one or more actual measurement values is outside the acceptable limits of at least one expected measurement value of the one or more expected measurement values; and means for reporting error information relating to the at least one actual measurement value of the one or more actual measurement values.

Clause 58. The network node of clause 57, wherein: the error information includes a bit map including flags indicating which parameters of the at least one actual measurement value is outside the acceptable limits.

Clause 59. The network node of any of clauses 57 to 58, wherein: the error information includes an indication of a degree to which the at least one actual measurement is outside the acceptable limits.

Clause 60. The network node of any of clauses 55 to 59, wherein the first set of one or more hashed values is based on application of the one or more hashing operations to: one or more expected PRS reference signal received power (PRS-RSRP) measurement values; one or more PRS-RSRP uncertainty values associated with the one or more expected PRS-RSRP measurement values; one or more expected reference-signal-time-difference (RSTD) measurement values; one or more RSTD uncertainty values associated with the expected one or more RSTD measurement values; one or more expected angle-of-arrival (AoA) measurement values; one or more AoA uncertainty values associated with the one or more AoA measurement values; one or more expected angle-of-departure (AoD) measurement values; one or more AoD uncertainty values associated with the one or more AoD measurement values; one or more expected zenith-of-arrival (ZoA) measurement values; one or more ZoA expected uncertainty values associated with the one or more ZoA measurement values; one or more expected zenith-of-departure (ZoD) measurement values; one or more expected ZoD uncertainty values associated with the one or more ZoD measurement values; or any combination thereof.

Clause 61. The network node of any of clauses 55 to 60, wherein the second set of one or more hashed values is based on application of the one or more hashing operations to: one or more actual reference signal received power (RSRP) measurement values; one or more actual relative-signal-time-difference (RSTD) measurement values; one or more actual angle-of-arrival (AoA) measurement values; one or more actual zenith-of-arrival (ZoA) measurement values; one or more actual zenith-of-departure (ZoD) measurement values; or any combination thereof.

Clause 62. The network node of any of clauses 55 to 61, wherein: the first set of one or more hashed values includes a hashed value of size L respectively associated with each of the one or more expected measurement values; and the second set of one or more hashed values includes a hashed value of size L respectively associated with each of the one or more actual measurement values.

Clause 63. The network node of clause 62, further comprising: means for receiving a first final hashed value of size L, wherein the first final hashed value is based on all hashed values of the first set of one or more hashed values; and means for receiving a second final hashed value of size L wherein the second final hashed value is based on all hashed values of the second set of one or more hashed values.

Clause 64. The network node of any of clauses 55 to 61, wherein: the first set of one or more hashed values includes a hashed value of size Z collectively associated with multiple expected measurement values of the one or more expected measurement values; and the second set of one or more hashed values includes a hashed value of size Z collectively associated with multiple actual measurement values of the one or more actual measurement values; and Z is based on a transport block size computation determined as Z=#layers*spectraleff*#REs where #layers is a number of control information layers, spectraleff is a spectral efficiency, and #REs is a number of resource elements.

Clause 65. The network node of any of clauses 55 to 64, wherein: the first set of one or more hashed values is received using a Long-Term Evolution Positioning Protocol (LPP).

Clause 66. The network node of any of clauses 55 to 65, wherein: the network node is a base station; the one or more PRS resources are uplink PRS (UL-PRS) resources; and the second set of one or more hashed values are received from a user equipment (UE).

Clause 67. The network node of any of clauses 55 to 64, wherein: the network node is a user equipment (UE); the one or more PRS resources are downlink PRS (DL-PRS) resources; and the first set of one or more hashed values is received from a base station.

Clause 68. The network node of any of clauses 55 to 64, wherein: the network node is a first user equipment (UE); the first set of one or more hashed values are received from a second UE; and the one or more PRS resources are sidelink PRS (SL-PRS) resources.

Clause 69. The network node of any of clauses 55 to 64, wherein: the network node is a user equipment (UE); and the first set of one or more hashed values is received in radio resource control (RRC) information.

Clause 70. The network node of clause 69, wherein: the RRC information is carried in a physical downlink shared channel (PDSCH), a physical sidelink shared channel (PSSCH), or a combination thereof.

Clause 71. The network node of any of clauses 55 to 64, wherein: the first set of one or more hashed values is received in one or more medium access control-control elements (MAC-CEs) carried in a physical download control channel PDCCH.

Clause 72. The network node of any of clauses 55 to 64, wherein the first set of one or more hashed values is received in: one or more medium access control-control elements (MAC-CEs) carried in a physical sidelink control channel (PSCCH), sidelink control information carried in the PSCCH, or a combination thereof.

Clause 73. The network node of any of clauses 55 to 72, wherein the means for determining whether the one or more actual measurement values of the one or more PRS resources are within acceptable limits of the one or more expected measurement values comprises: means for executing an assignment operation to assign one or more hashed values of the second set of hashed values to a set of hashed bins, wherein the set of hashed bins are based on the first set of hashed values; and means for reporting information relating to one or more hashed values of the second set of hashed values that are not assignable to an allowed hashed bin of the set of hashed bins.

Clause 74. A network node, comprising: means for receiving, from a location server, a first set of one or more hashed values, wherein the first set of one or more hashed values is based on one or more hashing operations applied to one or more expected measurement values, wherein the one or more expected measurement values correspond to expected measurements of one or more positioning reference signal (PRS) resources of one or more transmission-reception points (TRPs) measured by a user equipment (UE) during a positioning session; and means for using the first set of one or more hashed values for PRS attack detection.

Clause 75. The network node of clause 74, wherein the means for using the first set of one or more hashed values for PRS attack detection comprises: means for transmitting the first set of one or more hashed values to the UE; and means for receiving an indication from the UE that one or more actual measurement values made by the UE are outside of acceptable limits of one or more expected measurement values.

Clause 76. The network node of clause 75, wherein: the indication from the UE includes a bit map including flags indicating which parameters of the one or more actual measurement values are outside the acceptable limits.

Clause 77. The network node of any of clauses 75 to 76, wherein: the indication from the UE includes an indication of a degree to which the one or more actual measurement values are outside the acceptable limits.

Clause 78. The network node of any of clauses 75 to 77, further comprising: means for reporting error information, to the location server, relating to the one or more actual measurement values made by the UE that are outside of the acceptable limits of the one or more expected measurement values.

Clause 79. The network node of any of clauses 74 to 78, wherein the means for using the first set of one or more hashed values for PRS attack detection comprises: means for receiving a second set of one or more hashed values corresponding to one or more actual measurement values taken by the UE of the one or more PRS resources; and means for determining whether the one or more actual measurement values of the one or more PRS resources are within acceptable limits of the one or more expected measurement values based on a comparison of a second set of one or more hashed values with the first set of one or more hashed values, wherein the second set of one or more hashed values is based on application of the one or more hashing operations to the one or more actual measurement values.

Clause 80. The network node of clause 79, wherein the second set of one or more hashed values is based on applying the one or more hashing operations to: one or more actual reference signal received power (RSRP) measurement values; one or more expected relative-signal-time-difference (RSTD) measurement values; one or more expected angle-of-arrival (AoA) measurement values; or a combination thereof.

Clause 81. The network node of any of clauses 74 to 80, wherein the first set of one or more hashed values is based on application of the one or more hashing operations to: one or more expected PRS reference signal received power (PRS-RSRP) measurement values; one or more expected PRS-RSRP uncertainty values associated with the one or more expected PRS-RSRP measurement values; one or more expected reference-signal-time-difference (RSTD) measurement values; one or more expected RSTD uncertainty values associated with the one or more RSTD measurement values; one or more expected angle-of-arrival (AoA) measurement values; one or more expected AoA uncertainty values associated with the one or more AoA measurement values; one or more expected zenith-of-arrival (ZoA) measurement values; one or more expected ZoA uncertainty values associated with the one or more ZoA measurement values; one or more expected zenith-of-departure (ZoD) measurement values; one or more expected ZoD uncertainty values associated with the one or more ZoD measurement values; or any combination thereof.

Clause 82. A non-transitory computer-readable medium storing computer-executable instructions that, when executed by a network node, cause the network node to: receive a first set of one or more hashed values, wherein the first set of one or more hashed values is based on one or more hashing operations applied to one or more expected measurement values of one or more positioning reference signal (PRS) resources of one or more transmission-reception points (TRPs); measure the one or more PRS resources to obtain one or more actual measurement values; and determine whether the one or more actual measurement values of the one or more PRS resources are within acceptable limits of the one or more expected measurement values based on a comparison of a second set of one or more hashed values with the first set of one or more hashed values, wherein the second set of one or more hashed values is based on application of the one or more hashing operations to the one or more actual measurement values.

Clause 83. The non-transitory computer-readable medium of clause 82, further comprising computer-executable instructions that, when executed by the network node, cause the network node to: receive a configuration of the one or more PRS resources of the one or more TRPs to be measured during a positioning session.

Clause 84. The non-transitory computer-readable medium of any of clauses 82 to 83, further comprising computer-executable instructions that, when executed by the network node, cause the network node to: determine, based on the comparison of the second set of one or more hashed values with the first set of one or more hashed values, that at least one actual measurement value of the one or more actual measurement values is outside the acceptable limits of at least one expected measurement value of the one or more expected measurement values; and report error information relating to the at least one actual measurement value of the one or more actual measurement values.

Clause 85. The non-transitory computer-readable medium of clause 84, wherein: the error information includes a bit map including flags indicating which parameters of the at least one actual measurement value is outside the acceptable limits.

Clause 86. The non-transitory computer-readable medium of any of clauses 84 to 85, wherein: the error information includes an indication of a degree to which the at least one actual measurement is outside the acceptable limits.

Clause 87. The non-transitory computer-readable medium of any of clauses 82 to 86, wherein the first set of one or more hashed values is based on application of the one or more hashing operations to: one or more expected PRS reference signal received power (PRS-RSRP) measurement values; one or more PRS-RSRP uncertainty values associated with the one or more expected PRS-RSRP measurement values; one or more expected reference-signal-time-difference (RSTD) measurement values; one or more RSTD uncertainty values associated with the expected one or more RSTD measurement values; one or more expected angle-of-arrival (AoA) measurement values; one or more AoA uncertainty values associated with the one or more AoA measurement values; one or more expected angle-of-departure (AoD) measurement values; one or more AoD uncertainty values associated with the one or more AoD measurement values; one or more expected zenith-of-arrival (ZoA) measurement values; one or more ZoA expected uncertainty values associated with the one or more ZoA measurement values; one or more expected zenith-of-departure (ZoD) measurement values; one or more expected ZoD uncertainty values associated with the one or more ZoD measurement values; or any combination thereof.

Clause 88. The non-transitory computer-readable medium of any of clauses 82 to 87, wherein the second set of one or more hashed values is based on application of the one or more hashing operations to: one or more actual reference signal received power (RSRP) measurement values; one or more actual relative-signal-time-difference (RSTD) measurement values; one or more actual angle-of-arrival (AoA) measurement values; one or more actual zenith-of-arrival (ZoA) measurement values; one or more actual zenith-of-departure (ZoD) measurement values; or any combination thereof.

Clause 89. The non-transitory computer-readable medium of any of clauses 82 to 88, wherein: the first set of one or more hashed values includes a hashed value of size L respectively associated with each of the one or more expected measurement values; and the second set of one or more hashed values includes a hashed value of size L respectively associated with each of the one or more actual measurement values.

Clause 90. The non-transitory computer-readable medium of clause 89, further comprising computer-executable instructions that, when executed by the network node, cause the network node to: receive a first final hashed value of size L, wherein the first final hashed value is based on all hashed values of the first set of one or more hashed values; and receive a second final hashed value of size L wherein the second final hashed value is based on all hashed values of the second set of one or more hashed values.

Clause 91. The non-transitory computer-readable medium of any of clauses 82 to 89, wherein: the first set of one or more hashed values includes a hashed value of size Z collectively associated with multiple expected measurement values of the one or more expected measurement values; and the second set of one or more hashed values includes a hashed value of size Z collectively associated with multiple actual measurement values of the one or more actual measurement values; and Z is based on a transport block size computation determined as Z=#layers*spectraleff*#REs where #layers is a number of control information layers, spectraleff is a spectral efficiency, and #REs is a number of resource elements.

Clause 92. The non-transitory computer-readable medium of any of clauses 82 to 91, wherein: the first set of one or more hashed values is received using a Long-Term Evolution Positioning Protocol (LPP).

Clause 93. The non-transitory computer-readable medium of any of clauses 82 to 91, wherein: the network node is a base station; the one or more PRS resources are uplink PRS (UL-PRS) resources; and the second set of one or more hashed values are received from a user equipment (UE).

Clause 94. The non-transitory computer-readable medium of any of clauses 82 to 91, wherein: the network node is a user equipment (UE); the one or more PRS resources are downlink PRS (DL-PRS) resources; and the first set of one or more hashed values is received from a base station.

Clause 95. The non-transitory computer-readable medium of any of clauses 82 to 91, wherein: the network node is a first user equipment (UE); the first set of one or more hashed values are received from a second UE; and the one or more PRS resources are sidelink PRS (SL-PRS) resources.

Clause 96. The non-transitory computer-readable medium of any of clauses 82 to 91, wherein: the network node is a user equipment (UE); and the first set of one or more hashed values is received in radio resource control (RRC) information.

Clause 97. The non-transitory computer-readable medium of clause 96, wherein: the RRC information is carried in a physical downlink shared channel (PDSCH), a physical sidelink shared channel (PSSCH), or a combination thereof.

Clause 98. The non-transitory computer-readable medium of any of clauses 82 to 91, wherein: the first set of one or more hashed values is received in one or more medium access control-control elements (MAC-CEs) carried in a physical download control channel PDCCH.

Clause 99. The non-transitory computer-readable medium of any of clauses 82 to 91, wherein the first set of one or more hashed values is received in: one or more medium access control-control elements (MAC-CEs) carried in a physical sidelink control channel (PSCCH), sidelink control information carried in the PSCCH, or a combination thereof.

Clause 100. The non-transitory computer-readable medium of any of clauses 82 to 99, wherein the computer-executable instructions that, when executed by the network node, cause the network node to determine whether the one or more actual measurement values of the one or more PRS resources are within acceptable limits of the one or more expected measurement values comprise computer-executable instructions that, when executed by the network node, cause the network node to: execute an assignment operation to assign one or more hashed values of the second set of hashed values to a set of hashed bins, wherein the set of hashed bins are based on the first set of hashed values; and report information relating to one or more hashed values of the second set of hashed values that are not assignable to an allowed hashed bin of the set of hashed bins.

Clause 101. A non-transitory computer-readable medium storing computer-executable instructions that, when executed by a network node, cause the network node to: receive, from a location server, a first set of one or more hashed values, wherein the first set of one or more hashed values is based on one or more hashing operations applied to one or more expected measurement values, wherein the one or more expected measurement values correspond to expected measurements of one or more positioning reference signal (PRS) resources of one or more transmission-reception points (TRPs) measured by a user equipment (UE) during a positioning session; and use the first set of one or more hashed values for PRS attack detection.

Clause 102. The non-transitory computer-readable medium of clause 101, wherein the computer-executable instructions that, when executed by the network node, cause the network node to use the first set of one or more hashed values for PRS attack detection comprise computer-executable instructions that, when executed by the network node, cause the network node to: transmit the first set of one or more hashed values to the UE; and receive an indication from the UE that one or more actual measurement values made by the UE are outside of acceptable limits of one or more expected measurement values.

Clause 103. The non-transitory computer-readable medium of clause 102, wherein: the indication from the UE includes a bit map including flags indicating which parameters of the one or more actual measurement values are outside the acceptable limits.

Clause 104. The non-transitory computer-readable medium of any of clauses 102 to 103, wherein: the indication from the UE includes an indication of a degree to which the one or more actual measurement values are outside the acceptable limits.

Clause 105. The non-transitory computer-readable medium of any of clauses 102 to 104, further comprising computer-executable instructions that, when executed by the network node, cause the network node to: report error information, to the location server, relating to the one or more actual measurement values made by the UE that are outside of the acceptable limits of the one or more expected measurement values.

Clause 106. The non-transitory computer-readable medium of any of clauses 101 to 105, wherein the computer-executable instructions that, when executed by the network node, cause the network node to use the first set of one or more hashed values for PRS attack detection comprise computer-executable instructions that, when executed by the network node, cause the network node to: receive a second set of one or more hashed values corresponding to one or more actual measurement values taken by the UE of the one or more PRS resources; and determine whether the one or more actual measurement values of the one or more PRS resources are within acceptable limits of the one or more expected measurement values based on a comparison of a second set of one or more hashed values with the first set of one or more hashed values, wherein the second set of one or more hashed values is based on application of the one or more hashing operations to the one or more actual measurement values.

Clause 107. The non-transitory computer-readable medium of clause 106, wherein the second set of one or more hashed values is based on applying the one or more hashing operations to: one or more actual reference signal received power (RSRP) measurement values; one or more expected relative-signal-time-difference (RSTD) measurement values; one or more expected angle-of-arrival (AoA) measurement values; or a combination thereof.

Clause 108. The non-transitory computer-readable medium of any of clauses 101 to 107, wherein the first set of one or more hashed values is based on application of the one or more hashing operations to: one or more expected PRS reference signal received power (PRS-RSRP) measurement values; one or more expected PRS-RSRP uncertainty values associated with the one or more expected PRS-RSRP measurement values; one or more expected reference-signal-time-difference (RSTD) measurement values; one or more expected RSTD uncertainty values associated with the one or more RSTD measurement values; one or more expected angle-of-arrival (AoA) measurement values; one or more expected AoA uncertainty values associated with the one or more AoA measurement values; one or more expected zenith-of-arrival (ZoA) measurement values; one or more expected ZoA uncertainty values associated with the one or more ZoA measurement values; one or more expected zenith-of-departure (ZoD) measurement values; one or more expected ZoD uncertainty values associated with the one or more ZoD measurement values; or any combination thereof.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

1. A method of wireless communication performed by a network node, comprising:
receiving a first set of one or more hashed values, wherein the first set of one or more hashed values is based on one or more hashing operations applied to one or more expected measurement values of one or more positioning reference signal (PRS) resources of one or more transmission-reception points (TRPs);
measuring the one or more PRS resources to obtain one or more actual measurement values; and
determining whether the one or more actual measurement values of the one or more PRS resources are within acceptable limits of the one or more expected measurement values based on a comparison of a second set of one or more hashed values with the first set of one or more hashed values, wherein the second set of one or more hashed values is based on application of the one or more hashing operations to the one or more actual measurement values.

2. (canceled)

3. The method of claim 1, further comprising:
determining, based on the comparison of the second set of one or more hashed values with the first set of one or more hashed values, that at least one actual measurement value of the one or more actual measurement values is outside the acceptable limits of at least one expected measurement value of the one or more expected measurement values; and
reporting error information relating to the at least one actual measurement value of the one or more actual measurement values.

4. (canceled)

5. (canceled)

6. The method of claim 1, wherein the first set of one or more hashed values is based on application of the one or more hashing operations to:
one or more expected PRS reference signal received power (PRS-RSRP) measurement values;
one or more PRS-RSRP uncertainty values associated with the one or more expected PRS-RSRP measurement values;
one or more expected reference-signal-time-difference (RSTD) measurement values;
one or more RSTD uncertainty values associated with the expected one or more RSTD measurement values;
one or more expected angle-of-arrival (AoA) measurement values;
one or more AoA uncertainty values associated with the one or more AoA measurement values;
one or more expected angle-of-departure (AoD) measurement values;
one or more AoD uncertainty values associated with the one or more AoD measurement values;
one or more expected zenith-of-arrival (ZoA) measurement values;
one or more ZoA expected uncertainty values associated with the one or more ZoA measurement values;
one or more expected zenith-of-departure (ZoD) measurement values;
one or more expected ZoD uncertainty values associated with the one or more ZoD measurement values; or
any combination thereof.

7. The method of claim 1, wherein the second set of one or more hashed values is based on application of the one or more hashing operations to:
one or more actual reference signal received power (RSRP) measurement values;
one or more actual relative-signal-time-difference (RSTD) measurement values;
one or more actual angle-of-arrival (AoA) measurement values;
one or more actual zenith-of-arrival (ZoA) measurement values;
one or more actual zenith-of-departure (ZoD) measurement values; or
any combination thereof.

8. (canceled)

9. (canceled)

10. The method of claim 1, wherein:
the first set of one or more hashed values includes a hashed value of size Z collectively associated with multiple expected measurement values of the one or more expected measurement values; and
the second set of one or more hashed values includes a hashed value of size Z collectively associated with multiple actual measurement values of the one or more actual measurement values; and
Z is based on a transport block size computation determined as
$$Z = \# layers * {spectral}_{eff} * \# REs$$
where
#layers is a number of control information layers,
spectral_{eff} is a spectral efficiency, and
#REs is a number of resource elements.

11. (canceled)

12. The method of claim 1, wherein:
the network node is a base station;
the one or more PRS resources are uplink PRS (UL-PRS) resources; and
the second set of one or more hashed values are received from a user equipment (UE).

13. The method of claim 1, wherein:
the network node is a user equipment (UE);
the one or more PRS resources are downlink PRS (DL-PRS) resources; and
the first set of one or more hashed values is received from a base station.

14. The method of claim 1, wherein:
the network node is a first user equipment (UE);
the first set of one or more hashed values are received from a second UE; and
the one or more PRS resources are sidelink PRS (SL-PRS) resources.

15. The method of claim 1, wherein:
the network node is a user equipment (UE); and
the first set of one or more hashed values is received in radio resource control (RRC) information.

16. (canceled)

17. (canceled)

18. (canceled)

19. (canceled)

20. A method of wireless communication performed by a network node comprising:
receiving, from a location server, a first set of one or more hashed values, wherein the first set of one or more hashed values is based on one or more hashing operations applied to one or more expected measurement values, wherein the one or more expected measurement values correspond to expected measurements of one or more positioning reference signal (PRS) resources of one or more transmission-reception points (TRPs) measured by a user equipment (UE) during a positioning session; and
using the first set of one or more hashed values for PRS attack detection.

21. The method of claim 20, wherein using the first set of one or more hashed values for PRS attack detection comprises:
transmitting the first set of one or more hashed values to the UE; and
receiving an indication from the UE that one or more actual measurement values made by the UE are outside of acceptable limits of one or more expected measurement values.

22. (canceled)

23. (canceled)

24. (canceled)

25. The method of claim 20, wherein using the first set of one or more hashed values for PRS attack detection comprises:
receiving a second set of one or more hashed values corresponding to one or more actual measurement values taken by the UE of the one or more PRS resources; and
determining whether the one or more actual measurement values of the one or more PRS resources are within acceptable limits of the one or more expected measurement values based on a comparison of the second set of one or more hashed values with the first set of one or more hashed values, wherein the second set of one or more hashed values is based on application of the one or more hashing operations to the one or more actual measurement values.

26. (canceled)

27. The method of claim 20, wherein the first set of one or more hashed values is based on application of the one or more hashing operations to:
one or more expected PRS reference signal received power (PRS-RSRP) measurement values;
one or more expected PRS-RSRP uncertainty values associated with the one or more expected PRS-RSRP measurement values;
one or more expected reference-signal-time-difference (RSTD) measurement values;
one or more expected RSTD uncertainty values associated with the one or more RSTD measurement values;
one or more expected angle-of-arrival (AoA) measurement values;
one or more expected AoA uncertainty values associated with the one or more AoA measurement values;
one or more expected zenith-of-arrival (ZoA) measurement values;
one or more expected ZoA uncertainty values associated with the one or more ZoA measurement values;
one or more expected zenith-of-departure (ZoD) measurement values;
one or more expected ZoD uncertainty values associated with the one or more ZoD measurement values; or
any combination thereof.

28. A network node, comprising:
a memory;
at least one transceiver; and
at least one processor communicatively coupled to the memory and the at least one transceiver, the at least one processor configured to:
receive, via the at least one transceiver, a first set of one or more hashed values, wherein the first set of one or more hashed values is based on one or more hashing operations applied to one or more expected measurement values of one or more positioning reference signal (PRS) resources of one or more transmission-reception points (TRPs);
measure the one or more PRS resources to obtain one or more actual measurement values; and
determine whether the one or more actual measurement values of the one or more PRS resources are within acceptable limits of the one or more expected measurement values based on a comparison of a second set of one or more hashed values with the first set of one or more hashed values, wherein the second set of one or more hashed values is based on application of the one or more hashing operations to the one or more actual measurement values.

29. (canceled)

30. The network node of claim 28, wherein the at least one processor is further configured to:
determine, based on the comparison of the second set of one or more hashed values with the first set of one or more hashed values, that at least one actual measurement value of the one or more actual measurement values is outside the acceptable limits of at least one expected measurement value of the one or more expected measurement values; and
report, via the at least one transceiver, error information relating to the at least one actual measurement value of the one or more actual measurement values.

31. (canceled)

32. (canceled)

33. The network node of claim 28, wherein the first set of one or more hashed values is based on application of the one or more hashing operations to:
one or more expected PRS reference signal received power (PRS-RSRP) measurement values;
one or more PRS-RSRP uncertainty values associated with the one or more expected PRS-RSRP measurement values;
one or more expected reference-signal-time-difference (RSTD) measurement values;
one or more RSTD uncertainty values associated with the expected one or more RSTD measurement values;
one or more expected angle-of-arrival (AoA) measurement values;
one or more AoA uncertainty values associated with the one or more AoA measurement values;
one or more expected angle-of-departure (AoD) measurement values;
one or more AoD uncertainty values associated with the one or more AoD measurement values;
one or more expected zenith-of-arrival (ZoA) measurement values;
one or more ZoA expected uncertainty values associated with the one or more ZoA measurement values;
one or more expected zenith-of-departure (ZoD) measurement values;
one or more expected ZoD uncertainty values associated with the one or more ZoD measurement values; or
any combination thereof.

34. The network node of claim 28, wherein the second set of one or more hashed values is based on application of the one or more hashing operations to:
one or more actual reference signal received power (RSRP) measurement values;
one or more actual relative-signal-time-difference (RSTD) measurement values;
one or more actual angle-of-arrival (AoA) measurement values;
one or more actual zenith-of-arrival (ZoA) measurement values;
one or more actual zenith-of-departure (ZoD) measurement values; or
any combination thereof.

35. (canceled)

36. (canceled)

37. The network node of claim 28, wherein:
the first set of one or more hashed values includes a hashed value of size Z collectively associated with multiple expected measurement values of the one or more expected measurement values; and
the second set of one or more hashed values includes a hashed value of size Z collectively associated with multiple actual measurement values of the one or more actual measurement values; and
Z is based on a transport block size computation determined as
$$Z = \# layers * {spectral}_{eff} * \# REs$$
where
#layers is a number of control information layers,
spectral_{eff} is a spectral efficiency, and
#REs is a number of resource elements.

38. (canceled)

39. The network node of claim 28, wherein:
the network node is a base station;
the one or more PRS resources are uplink PRS (UL-PRS) resources; and
the second set of one or more hashed values are received from a user equipment (UE).

40. The network node of claim 28, wherein:
the network node is a user equipment (UE);
the one or more PRS resources are downlink link PRS (DL-PRS) resources; and
the first set of one or more hashed values is received from a base station.

41. The network node of claim 28, wherein:
the network node is a first user equipment (UE);
the first set of one or more hashed values are received from a second UE; and
the one or more PRS resources are sidelink PRS (SL-PRS) resources.

42. (canceled)

43. (canceled)

44. The network node of claim 28, wherein:
the first set of one or more hashed values is received in one or more medium access control-control elements (MAC-CEs) carried in a physical download control channel PDCCH.

45. The network node of claim 28, wherein the first set of one or more hashed values is received in:
one or more medium access control-control elements (MAC-CEs) carried in a physical sidelink control channel (PSCCH),
sidelink control information carried in the PSCCH, or
a combination thereof.

46. The network node of claim 28, wherein the at least one processor configured to determining whether the one or more actual measurement values of the one or more PRS resources are within acceptable limits of the one or more expected measurement values comprises the at least one processor configured to:
execute an assignment operation to assign one or more hashed values of the second set of hashed values to a set of hashed bins, wherein the set of hashed bins are based on the first set of hashed values; and
report, via the at least one transceiver, information relating to one or more hashed values of the second set of hashed values that are not assignable to an allowed hashed bin of the set of hashed bins.

47. A network node, comprising:
a memory;
at least one transceiver; and
at least one processor communicatively coupled to the memory and the at least one transceiver, the at least one processor configured to:
receive, via the at least one transceiver, from a location server, a first set of one or more hashed values, wherein the first set of one or more hashed values is based on one or more hashing operations applied to one or more expected measurement values, wherein the one or more expected measurement values correspond to expected measurements of one or more positioning reference signal (PRS) resources of one or more transmission-reception points (TRPs) measured by a user equipment (UE) during a positioning session; and
use the first set of one or more hashed values for PRS attack detection.

48. The network node of claim 47, wherein the at least one processor configured to use the first set of one or more hashed values for PRS attack detection comprises the at least one processor configured to:
transmit, via the at least one transceiver, the first set of one or more hashed values to the UE; and
receive, via the at least one transceiver, an indication from the UE that one or more actual measurement values made by the UE are outside of acceptable limits of one or more expected measurement values.

49. (canceled)

50. (canceled)

51. The network node of claim 48, wherein the at least one processor is further configured to:
report, via the at least one transceiver, error information, to the location server, relating to the one or more actual measurement values made by the UE that are outside of the acceptable limits of the one or more expected measurement values.

52. The network node of claim 47, wherein the at least one processor configured to use the first set of one or more hashed values for PRS attack detection comprises the at least one processor configured to:
receive, via the at least one transceiver, a second set of one or more hashed values corresponding to one or more actual measurement values taken by the UE of the one or more PRS resources; and
determine whether the one or more actual measurement values of the one or more PRS resources are within acceptable limits of the one or more expected measurement values based on a comparison of the second set of one or more hashed values with the first set of one or more hashed values, wherein the second set of one or more hashed values is based on application of the one or more hashing operations to the one or more actual measurement values.

53. The network node of claim 52, wherein the second set of one or more hashed values is based on applying the one or more hashing operations to:
one or more actual reference signal received power (RSRP) measurement values;
one or more expected relative-signal-time-difference (RSTD) measurement values;
one or more expected angle-of-arrival (AoA) measurement values; or
a combination thereof.

54. The network node of claim 47, wherein the first set of one or more hashed values is based on application of the one or more hashing operations to:
one or more expected PRS reference signal received power (PRS-RSRP) measurement values;
one or more expected PRS-RSRP uncertainty values associated with the one or more expected PRS-RSRP measurement values;
one or more expected reference-signal-time-difference (RSTD) measurement values;
one or more expected RSTD uncertainty values associated with the one or more RSTD measurement values;
one or more expected angle-of-arrival (AoA) measurement values;
one or more expected AoA uncertainty values associated with the one or more AoA measurement values;
one or more expected zenith-of-arrival (ZoA) measurement values;
one or more expected ZoA uncertainty values associated with the one or more ZoA measurement values;
one or more expected zenith-of-departure (ZoD) measurement values;
one or more expected ZoD uncertainty values associated with the one or more ZoD measurement values; or
any combination thereof.
